(19) United States
(12) Patent Application Publication
(10) Pub. No.: US 2025/0208021 A1
(43) Pub. Date: Jun. 26, 2025

(54) BROADBAND SIGNAL COLLECTION EFFICIENCY IN FLOW CYTOMETERS AND CELL SORTERS

(71) Applicant: CYTEK BIOSCIENCES, INC., Fremont, CA (US)

(72) Inventors: Bing Shan, Fremont, CA (US); Ming Yan, Fremont, CA (US)

(73) Assignee: CYTEK BIOSCIENCES, INC., Fremont, CA (US)

(21) Appl. No.: 18/969,240

(22) Filed: Dec. 4, 2024

Related U.S. Application Data
(60) Provisional application No. 63/606,037, filed on Dec. 4, 2023.

(51) Int. Cl. G01N 15/1434; G01N 15/1409; G01N 15/149

(52) U.S. Cl. CPC G01N 15/1434; G01N 15/1409; G01N 2015/1411; G01N 15/149

(57) ABSTRACT

In accordance with one embodiment, a method comprises exciting differing fluorochromes to fluorescence that mark a plurality of moving cells; collecting a broadband light signal having a broadband wavelength range from the fluorescence of the differing fluorochromes; splitting out wavelength ranges in the broadband light signal into smaller wavelength ranges in light signal paths; separately detecting, with differing photo detectors, the light signals in each of the smaller wavelength ranges in the light signal paths; generating digital signals, with analog to digital converters, from the detected light signals in the smaller wavelength ranges in the light signal paths; aligning the digital signals over the broadband wavelength range; and combining the aligned digital signals together into a full spectral response based on the broadband light signal having the broadband wavelength range.

### CROSS-REFERENCE TO RELATED APPLICATIONS

This United States (U.S.) patent application is a nonprovisional patent application claiming priority to U.S. Provisional Patent Application No. 63/606,037 filed on Dec. 4, 2023, by inventors Bing Shan, et al., titled IMPROVING BROADBAND SIGNAL COLLECTION EFFICIENCY IN FLOW CYTOMETERS AND CELL SORTERS, incorporated by reference for all intents and purposes. This U.S. patent application is related to U.S. patent application Ser. No. 15/659,610 filed on Oct. 5, 2017, by inventors Ming Yan, et al., titled COMPACT DETECTION MODULE FOR FLOW CYTOMETERS, incorporated by reference for all intents and purposes. This U.S. patent application is further related to U.S. patent application Ser. No. 15/942,430 filed on Mar. 30, 2018, by inventors Ming Yan, et al., titled COMPACT MULTI-COLOR FLOW CYTOMETER HAVING COMPACT DETECTION MODULE, also incorporated by reference for all intents and purposes.

### FIELD

The embodiments relate generally to flow cytometer and cell sorter systems.

### BACKGROUND

Flow cytometry is a technology that provides rapid analysis of physical and chemical characteristics of moving biological cells in the flow of a sample solution. Cell sorting further sorts out selected cells of interest into different containers (e.g., test tubes) for further usage (e.g., testing) or counting. The lab instruments that achieve these tasks are known as a flow cytometer and a cell sorter, also referred to as a sorting flow cytometer.

The biological cells or other particles are often stained or marked with one or more fluorescent dyes (fluorochromes) that can attach to the cell or other particle at a marker in the sample in order to make them more identifiable. Different fluorescent dyes can be excited by different laser light of different center wavelengths to better identify unknown cells and particles in the test sample. Flow cytometers utilize one or more lasers as light sources to strike the biological cells and the fluorescent dyes to produce scattered light signals and fluorescent light signals respectively. The fluorescent light signals and scattered light signals are received by photo detectors, such as photodiodes or photomultiplier tubes to form electrical signals and digitized to form digital signals that can be analyzed.

Cell populations in a sample solution can be analyzed and/or purified based on the fluorescent or light scattering characteristics that are detected. Flow cytometry provides a method to identify cells and their characteristics in solution and is commonly used for evaluating biological cells in peripheral blood, bone marrow, and other body fluids.

### BRIEF SUMMARY

The embodiments are best summarized by the claims that follow below. However briefly, in some aspects, the techniques described herein relate to a method for a flow cytometer, the method including: collecting, with an objective lens, fluorescent light from one or more moving cells and side scattered light off the one or more moving cells over a full bandwidth range between a minimum wavelength and a maximum wavelength that is desirable to detect; focusing, out of the objective lens, the fluorescent light and the side scattered light over the full bandwidth range into a spot size towards a focal point along a first optical axis; coupling, with a first optical coupling device, first light in a first wavelength range from the minimum wavelength to a first wavelength within the full bandwidth range into a first light detecting device, and allowing remaining light of the full bandwidth range to pass through towards a last light detecting device; transducing, with the first light detecting device, the first light into a first plurality of digital signals representing discrete portions of wavelengths over the first light of the first wavelength range; transducing, with the last light detecting device, the remaining light into a last plurality of digital signals representing discrete portions of wavelengths over the remaining light of the full bandwidth range; and receiving, with a processor, the first plurality of digital signals and the last plurality of digital signals and processing the digital signals into a combined spectral signal over the full bandwidth range.

In some aspects, the techniques described herein relate to a method, further including: prior to the transducing with the last light detecting device: coupling, with a second coupling device, second light in a second wavelength range from one or more nanometers above the maximum wavelength of the first light to a second wavelength within the full bandwidth range into a second light detecting device, and allowing remaining light of the full bandwidth range to pass through towards the last light detecting device; transducing, with the second light detecting device, the second light into a second plurality of digital signals representing discrete portions of wavelengths over the second light of the second wavelength range; and receiving, with the signal processor, the second plurality of digital signals and processing the first, second, and last plurality of digital signals into the combined spectral signal over the full bandwidth range.

In some aspects, the techniques described herein relate to a method, further including: after transducing with the second light detecting device and prior to the transducing with the last light detecting device: coupling, with a third coupling device, third light in a third wavelength range from one or more nanometers above the maximum wavelength of the second light to a third wavelength within the full bandwidth range into a third light detecting device, and allowing remaining light of the full bandwidth range to pass through towards the last light detecting device; transducing, with the third light detecting device, the third light into a third plurality of digital signals representing discrete portions of wavelengths over the third light of the third wavelength range; and receiving, with the signal processor, the third plurality of digital signals and processing the first, second, third and last plurality of digital signals into the combined spectral signal over the full bandwidth range.

In some aspects, the techniques described herein relate to a method, wherein: the first optical coupling device is one or more selected from the group consisting of a lens, an optical fiber, a beam splitter, a Bragg grating, and/or a mirror.

In some aspects, the techniques described herein relate to a method, wherein: each optical coupling device is one or more selected from the group consisting of a lens, an optical fiber, a beam splitter, a Bragg grating, and/or a mirror.

In some aspects, the techniques described herein relate to a method, wherein the first optical coupling device is a first beam splitter and the coupling includes: splitting off, with the first beam splitter; the first light in the first wavelength range from the minimum wavelength to a first wavelength within the full bandwidth range and allowing the remaining light of the full bandwidth range to pass through; and redirecting on a forty-five degree angle, with the first beam splitter, the first light in the first wavelength range towards the first light detecting device along a second optical axis.

In some aspects, the techniques described herein relate to a method, wherein the first optical coupling device is a first beam splitter and the first coupling includes: splitting off, with the first beam splitter; the first light in the first wavelength range from the minimum wavelength to a first wavelength within the full bandwidth range and allowing the remaining light of the full bandwidth range to pass through; and redirecting on an angle, with the first beam splitter, the first light in the first wavelength range towards the first light detecting device along a second optical axis; and the second optical coupling device is a second beam splitter and the second coupling includes: splitting off, with the second beam splitter, the second light in the second wavelength range from one or more nanometers above the maximum wavelength of the first light to a second wavelength within the full bandwidth range and allowing the remaining light of the full bandwidth range to pass through towards the third light detecting device; and redirecting on a forty-five degree angle, with the second beam splitter, the second light in the second wavelength range towards the second light detecting device along a third optical axis

In some aspects, the techniques described herein relate to a method, wherein the first optical coupling device is a first dichroic mirror and a first optical fiber, and the coupling includes: splitting off, with the first dichroic mirror; the first light in the first wavelength range from the minimum wavelength to a first wavelength within the full bandwidth range and allowing the remaining light of the full bandwidth range to pass through; redirecting on a forty-five degree angle, with the first dichroic mirror, the first light in the first wavelength range towards a first end of the first optical fiber along a second optical axis; and receiving, with a first end of the first optical fiber, the first light and launching the first light into the first light detecting device out of a second end of the first optical fiber.

In some aspects, the techniques described herein relate to a method, wherein the first optical coupling device is a first dichroic mirror and a first optical fiber, and the first coupling includes: splitting off, with the first dichroic mirror; the first light in the first wavelength range from the minimum wavelength to a first wavelength within the full bandwidth range and allowing the remaining light of the full bandwidth range to pass through; redirecting on a first angle, with the first dichroic mirror, the first light in the first wavelength range towards a first end of the first optical fiber along a second optical axis; and receiving, with a first end of the first optical fiber, the first light and launching the first light into the first light detecting device out of a second end of the first optical fiber; and the second optical coupling device is a second dichroic mirror and a second optical fiber, and the second coupling includes: splitting off, with the second dichroic mirror, the second light in the second wavelength range from the minimum wavelength to a first wavelength within the full bandwidth range and allowing the remaining light of the full bandwidth range to pass through; redirecting on a second angle, with the second dichroic mirror, the second light in the second wavelength range towards a first end of a second optical fiber along a second optical axis; and receiving, with the first end of the second optical fiber, the second light and launching the second light into the second light detecting device out of a second end of the second optical fiber.

In some aspects, the techniques described herein relate to a method, wherein: each light detecting device is a photodiode array detector with a plurality of mirrors in a first row on one side, and a plurality of wavelength filters and a plurality of photodetectors aligned together in a row on an opposite side to detect discrete portions of wavelengths over a bandwidth of light.

In some aspects, the techniques described herein relate to a method, wherein: each of the plurality of photodetectors is an avalanche photodiode.

In some aspects, the techniques described herein relate to a method, wherein: each light detecting device includes: a first grating to receive the light coupled into light detecting device along a first axis and reflect and first spread the light along a second axis; a second grating to receive the first spread of the light along the second axis and reflect and second spread the light along a third axis; and a photodiode array detector with a plurality of mirrors in a first row on one side, and a plurality of wavelength filters and a plurality of photodetectors aligned together in a row on an opposite side to detect discrete portions of wavelengths over a bandwidth of the light.

In some aspects, the techniques described herein relate to a method, wherein: each of the plurality of photodetectors in the photodiode array detector is an avalanche photodiode.

In some aspects, the techniques described herein relate to a method, wherein: each light detecting device is a photo-multiplier tube (PMT).

In some aspects, the techniques described herein relate to a flow cytometer including: a flow cell receiving moving biological cells in a sample fluid and a sheath fluid to wrap around the biological cells, the flow cell having an interrogation region to receive one or more laser beams from one or more lasers to strike the moving biological cells and form fluorescent light, side scatter light, and forward scattered light; an objective lens near the flow cell to collect the fluorescent light and the side scattered light over a full bandwidth range between a minimum wavelength and a maximum wavelength that is desirable to detect, and focus out of the objective lens, the fluorescent light and the side scattered light over the full bandwidth range into a spot size towards a focal point along a first optical axis; a first optical coupling device along the first optical axis before the focal point, the first optical coupling device redirecting a first light in a first wavelength range from the minimum wavelength to a first wavelength within the full bandwidth range along a second optical axis, and the first optical coupling device allowing remaining light of the full bandwidth range to pass through along the first optical axis; a first light detecting device receiving the first light along the second optical axis, the first light detecting device transducing the first light into a first plurality of digital signals representing discrete portions of wavelengths over the first light in the first wavelength range; a last light detecting device receiving the remaining light along the first optical axis, the third light detecting device transducing the remaining light into a last plurality of digital signals representing discrete portions of wavelengths in the remaining light of the full bandwidth range; and a processor coupled in communication with the first light detecting device and the last light detecting device, the signal processor receiving the first plurality of digital signals and the last plurality of digital signals and processing the digital signals into a combined spectral signal over the full bandwidth range.

In some aspects, the techniques described herein relate to a flow cytometer, further including: a second optical coupling device along the first optical axis between the first optical coupling device and the focal point, the first optical coupling device redirecting a second light in a second wavelength range from one or more nanometers above the maximum wavelength of the first light to a second wavelength within the full bandwidth range along a third optical axis, the second optical coupling device allowing the remaining light of the full bandwidth range to pass through along the first optical axis; a second light detecting device receiving the second light along the third optical axis, the second light detecting device transducing the second light into a second plurality of digital signals representing discrete portions of wavelengths over the second light in the second wavelength range; and wherein the signal processor is further coupled in communication with the second light detecting device to receive the second plurality of digital signals, and wherein the signal processor processes the first, second, and last plurality of digital signals into the combined spectral signal over the full bandwidth range.

In some aspects, the techniques described herein relate to a flow cytometer, further including: a third optical coupling device along the first optical axis between the second optical coupling device and the focal point, the third optical coupling device redirecting a third light in a third wavelength range from one or more nanometers above the maximum wavelength of the second light to a third wavelength within the full bandwidth range along a fourth optical axis, the third optical coupling device allowing the remaining light of the full bandwidth range to pass through along the first optical axis toward the last optical coupling device; a third light detecting device receiving the third light along the fourth optical axis, the third light detecting device transducing the third light into a third plurality of digital signals representing discrete portions of wavelengths over the third light in the third wavelength range; and wherein the signal processor is further coupled in communication with the third light detecting device to receive the third plurality of digital signals, and wherein the signal processor processes the first, second, third, and last plurality of digital signals into the combined spectral signal over the full bandwidth range.

In some aspects, the techniques described herein relate to a flow cytometer, wherein: the first optical coupling device is one or more selected from the group consisting of a lens, a Bragg grating, and/or a dichroic mirror and an optical fiber.

In some aspects, the techniques described herein relate to a flow cytometer, wherein: each of the optical coupling devices is one or more selected from the group consisting of a lens, a Bragg grating, and/or a dichroic mirror and an optical fiber.

In some aspects, the techniques described herein relate to a flow cytometer, wherein: each of the optical coupling devices is one or more selected from the group consisting of a lens, a Bragg grating, and/or a dichroic mirror and an optical fiber.

In some aspects, the techniques described herein relate to a method for improving a flow cytometer or cell sorter, the method including: exciting, with one or more laser beams, a plurality of differing fluorochromes to fluorescence that mark a plurality of moving cells; collecting a broadband light signal having a broadband wavelength range from the fluorescence of the plurality of differing fluorochromes; splitting out wavelength ranges in the collected broadband light signal into a plurality of smaller wavelength ranges in a plurality of light signal paths; separately detecting, with a plurality of differing photo detectors, the light signals in each of the plurality of smaller wavelength ranges in the plurality of light signal paths; generating a plurality of digital signals, with a plurality of analog to digital converters, from the detected light signals in each of the plurality of smaller wavelength ranges in the plurality of light signal paths; and aligning the plurality of digital signals over the broadband wavelength range; and combining the aligned plurality of digital signals together into a full spectral response based on the broadband light signal having the broadband wavelength range.

In some aspects, the techniques described herein relate to a method, wherein: the broadband wavelength range of the collected broadband light signal is from three hundred-twenty nanometers to one thousand nanometers.

In some aspects, the techniques described herein relate to a method, wherein: the broadband wavelength range of the collected broadband light signal is split out into two wavelength ranges in two light signal paths.

In some aspects, the techniques described herein relate to a method, wherein: a first wavelength range in a first light signal path is from three hundred twenty nanometers to four hundred eighty nanometers; and a second wavelength range in a second light signal path is from four hundred eighty nanometers to one thousand nanometers.

In some aspects, the techniques described herein relate to a method, wherein: the splitting out wavelength ranges in the collected broadband light signal into the plurality of smaller wavelength ranges in the plurality of light signal paths further includes: collecting at least one smaller wavelength range of the plurality of differing smaller wavelength ranges with a first end of an optical fiber and redirecting the light signal towards a first light detector; and launching the light signal out of the second end of the optical fiber into the first light detector.

In some aspects, the techniques described herein relate to a method, wherein: the first light detector is a linear array detector having a plurality of photo detectors aligned in a row.

In accordance with one embodiment, a method includes exciting differing fluorochromes to fluorescence that mark a plurality of moving cells; collecting a broadband light signal having a broadband wavelength range from the fluorescence of the differing fluorochromes; splitting out wavelength ranges in the broadband light signal into smaller wavelength ranges in light signal paths; separately detecting, with differing photo detectors, the light signals in each of the smaller wavelength ranges in the light signal paths; generating digital signals, with analog to digital converters, from the detected light signals in the smaller wavelength ranges in the light signal paths; aligning the digital signals over the broadband wavelength range; and combining the aligned digital signals together into a full spectral response based on the broadband light signal having the broadband wavelength range.

### BRIEF DESCRIPTIONS OF THE DRAWINGS

FIG. 1A is a conceptual diagram of a flow cytometer system and a sorting flow cytometer (cell sorter) system.

FIG. 1B is a conceptual diagram of an electro-optical system to excite and detect side scattered light by a biological cell and fluorescent light given off by excited fluorescent dyes (fluorochromes) with a single optical fiber and a single array detector.

FIG. 1C is a conceptual diagram with a magnified view of an objective lens and input end of the single optical fiber shown in FIG. 1B.

FIG. 1D illustrates a chart of chromatic focal shift associated with the single optical fiber and optical lens shown in FIG. 1C collecting a full bandwidth of the fluorescence and side scattered light signal.

FIG. 1E illustrates a conceptual diagram of a linear array detector with N detection channels and N photo detectors.

FIG. 1F illustrates a chart of the characteristics of standard antireflective (AR) coatings for optical components.

FIG. 2 is a conceptual diagram of an electro-optical system to excite and detect split wavelength ranges of side scattered light and fluorescent light with multiple beam splitters and multiple array detectors.

FIG. 3A is a conceptual diagram of an electro-optical system to excite and detect split wavelength ranges of side scattered light and fluorescent light with multiple optical fibers and multiple array detectors.

FIG. 3B is a chart of transmission characteristics of a beam splitting dichroic mirror.

FIG. 3C is a block diagram of filter characteristics of wavelength ranges of split detectors with an overlapping wavelength portion.

FIG. 3D is a block diagram of filter characteristics of wavelength ranges of split detectors with a spectrum gap or a non-overlapping wavelength portion.

FIG. 4A is a block diagram of a pair of linear array detectors packaged together with dual optical fiber inputs to detect two split wavelength ranges.

FIG. 4B is a pair of wavelength tables for the pair of linear array detectors shown in FIG. 4A.

FIG. 4C is a conceptual block diagram of a single detector channel for a plurality of detector channels in a linear array detector.

FIG. 4D is a diagram of a pair of linear array detectors housed together sharing an optical block.

FIG. 5 is a block diagram of N linear array detectors packaged together with N optical fiber inputs to detect N split wavelength ranges.

FIG. 6A is a block diagram of a pair of grating type detectors packaged together with dual optical fiber inputs to detect two split wavelength ranges.

FIG. 6B is a block diagram of three detectors of mixed types packaged together with three optical fiber inputs to detect three split wavelength ranges.

FIG. 7 illustrates a chart of chromatic focal shift associated with the dual optical fibers shown in FIG. 3A for collecting split bandwidth ranges of the fluorescence and side scattered light signal.

FIGS. 8A-8B illustrate a multimode fiber optic patch cable that can be used for the optical fibers shown in FIG. 3A.

FIG. 8C illustrates a chart of the characteristics of antireflective coatings for fiber optic patch cables.

FIG. 9A illustrates an octagon spatial detector arrangement.

FIG. 9B illustrates a hexagon spatial detector arrangement.

FIG. 9C illustrates a triangle spatial detector arrangement.

FIGS. 10A-10C illustrate capture of fluorescent light intensity over separate spectrum with different detectors and combining the separate spectrum together to form a full spectral signature.

### DETAILED DESCRIPTION

In the following detailed description of the disclosed embodiments, numerous specific details are set forth in order to provide a thorough understanding. However, it will be obvious to one skilled in the art that the disclosed embodiments may be practiced without these specific details. In other instances, well known methods, procedures, components, and subsystems have not been described in detail so as not to unnecessarily obscure aspects of the disclosed embodiments.

The disclosed embodiments include a method, apparatus and system for improving efficiency in broadband signal collection in a flow cytometer/cell sorter system by splitting up wavelength ranges in a broadband light signal into multiple paths, separately detecting the split up wavelength ranges, and then recombining spectral results with a central processor device. Generally, a broader bandwidth (320 nm to 1000 nm—broadband wavelength range) of input light signals to an electro optical subsystem can be split up, such as breaking it into two sections (e.g., 320 nm to 550 nm for one and 570 nm to 1000 nm for another) or (e.g., 320 nm to 480 nm and 480 nm to 1000 nm). Then two or more detectors can be used to detect light in the separate bandwidth sections and digital signals can be generated separately for each. Each array detector covers a narrower wavelength range than that of the overall bandwidth range. The separate digital signals are aligned over the wavelength ranges and combined together to provide the overall spectral results in a combined spectral signal.

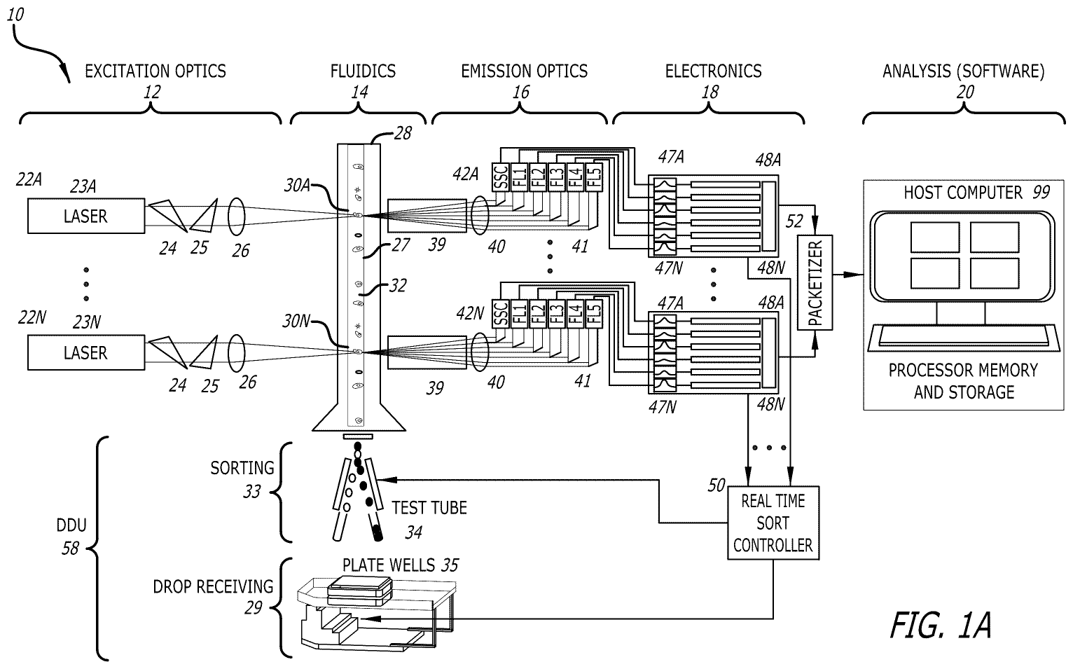

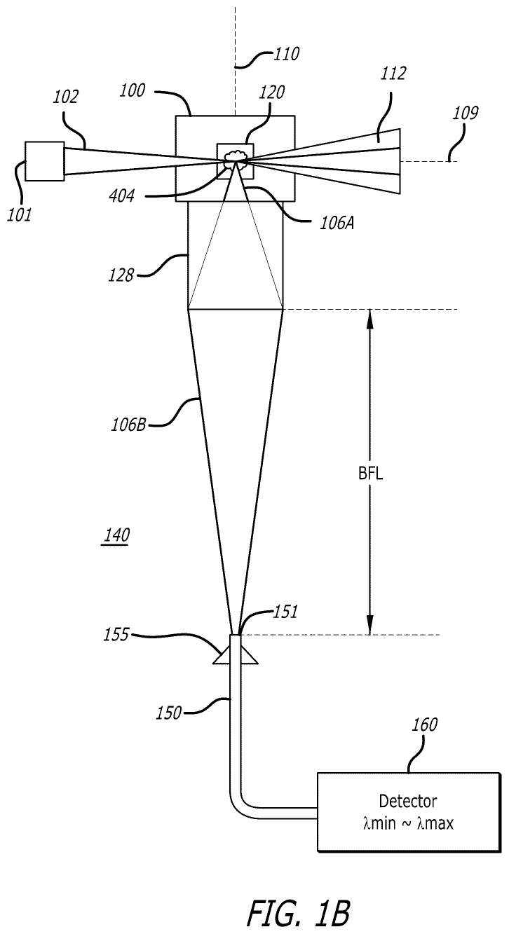

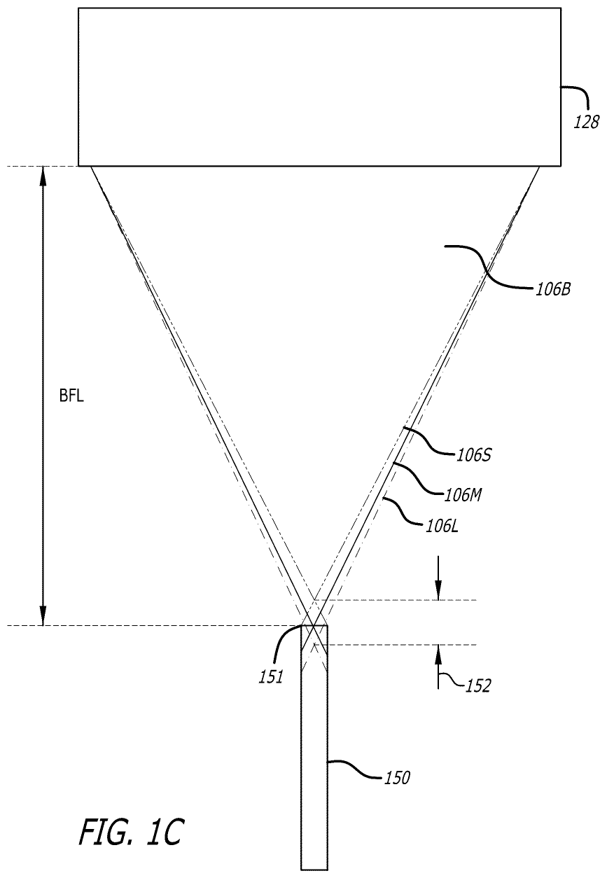

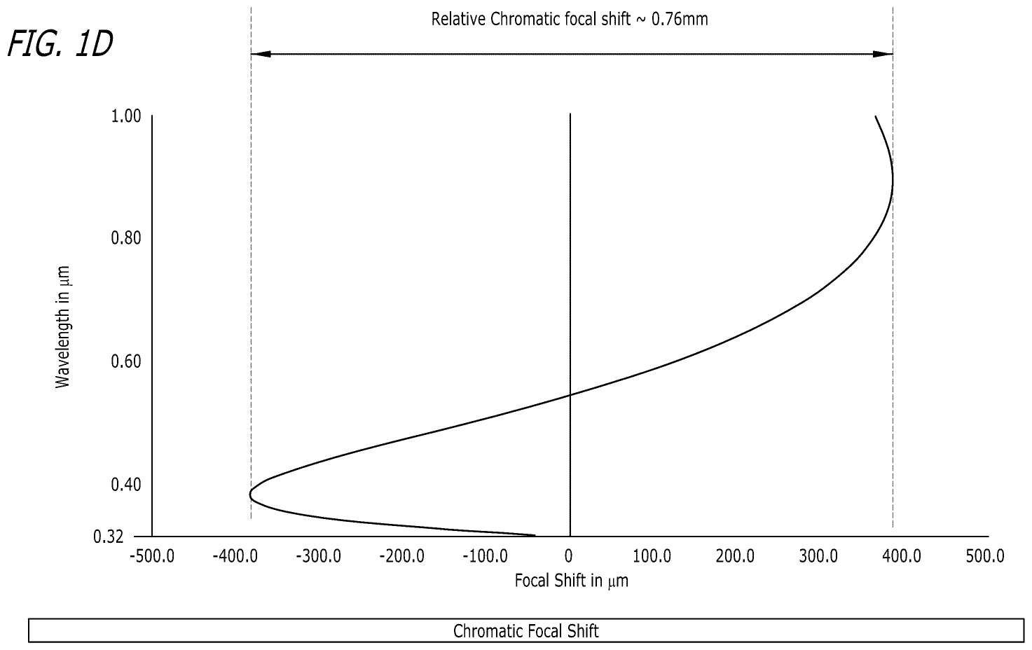

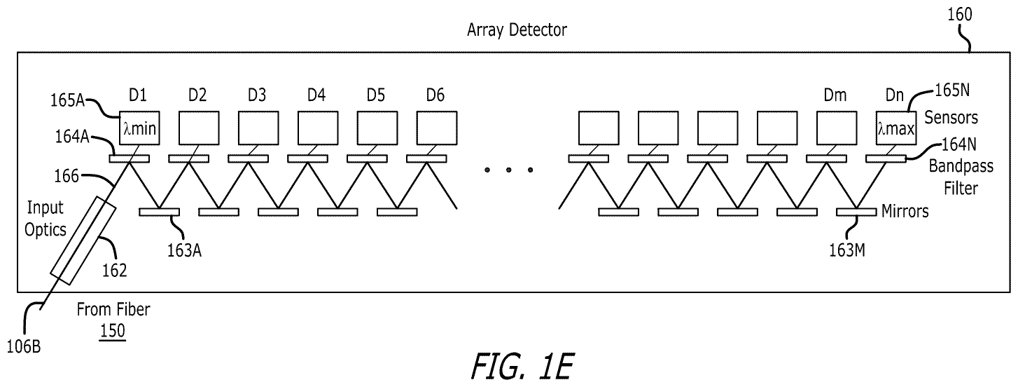

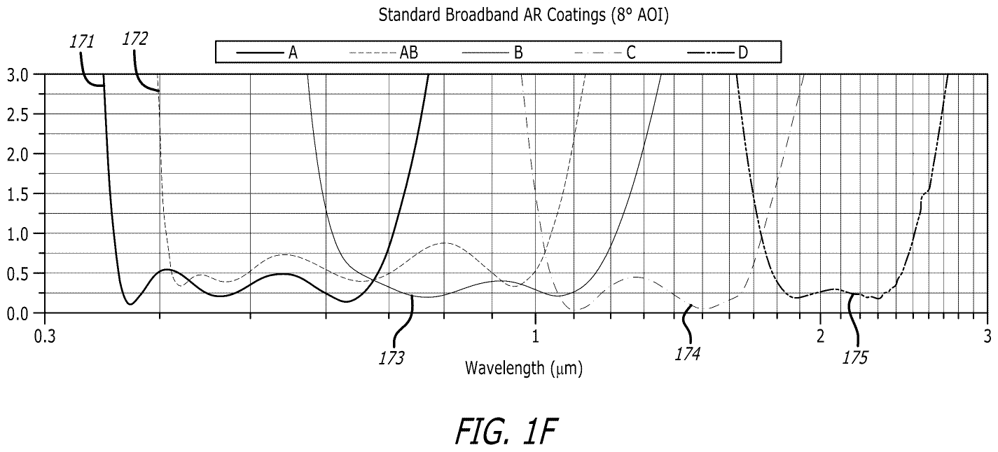

Referring now to FIG. 1A, a basic conceptual diagram of a cell sorter system (sorting flow cytometer) 10 is shown. Five major subsystems of the system 10 include an excitation optics system 12, a fluidics system 14, an emission optics system 16, an acquisition system 18, and an analysis system 20. The fluidics system 14 can include a sample loading system (see sample input station 130 shown in FIG. 1C), an interrogating system 28, a cell sorting system 33, and a droplet deposition (droplet receiving) system 29. Generally, a “system” and “subsystem” includes (electrical, mechanical, and electro-mechanical) hardware devices, software devices, or a combination thereof.

The excitation optics system 12 includes, for example, a plurality (e.g., two to five) of excitation channels 22A-22N each having a different laser device 23A-23N and one or more optical elements 24-26 to direct the different laser light to optical interrogation regions 30A-30N spaced apart along a line in a flow channel 27 of a flow cell 28. Example optical elements of the one or more one or more optical elements 24-26 include an optical prism and an optical lens. The excitation optics system 12 illuminates an optical interrogation region 30 in a flow cell 28. The fluidics system 14 carries a fluid sample 32 surrounded by a sheath fluid through each of a plurality of optical interrogation regions 30A-30N in the flow cell/flow channel.

The emission optics system 16 includes a plurality of detector arrays 42A-42N each of which, for example, includes one or more optical elements 40, such as an optical fiber and one or more lenses to direct fluorescent light and/or (forward, side, back) scattered light to various electro-optical detectors (transducers), including a side scatter (SSC) channel detector and a plurality (e.g., 16, 32, 48, 64) of fluorescent wavelength range optical detectors in each array, such as a first fluorescent optical detector (FL1) receiving a first wavelength range of fluorescent light, a second fluorescent optical detector (FL2) receiving a second wavelength range of fluorescent light, a third fluorescent optical detector (FL3) receiving a third wavelength range of fluorescent light, a fourth fluorescent optical detector (FL4) receiving a fourth wavelength range of fluorescent light, a fifth fluorescent optical detector (FL5) receiving a fifth wavelength range of fluorescent light, and so on to an Nth fluorescent optical detector (FLN) receiving an Nth wavelength range of fluorescent light. Each of the detector arrays 42A-42N receives light corresponding to the cells/particles that are struck and/or one or more fluorescent dyes that attached thereto and excited by the differing laser light in interrogation regions/points 30A-30N along the flow channel 27 of the flow cell 28 by each of the corresponding plurality of lasers 23A-23N. The emission optics system 16 gathers photons emitted or scattered from passing cells/particles and/or a fluorescent dyes attached to the cells/particles. The emission optics system 16 directs and focuses these collected photons onto the electro-optical detectors SSC, FL1, FL2, FL3, FL4, and FL5 in each detector array, such as by fiber optic (optical fiber) cables 39, one or more one or more lenses 40, and one or more mirrors/filters 41. Electro-optical detector SSC is a side scatter channel detector detecting light that scatters off the cell/particle. The electro-optical detectors FL1, FL2, FL3, FL4, and FL5 are fluorescent detectors may include band-pass, or long-pass, filters to detect a particular and differing fluorescence wavelength ranges from the different fluorescent dyes excited by the different lasers. Each electro-optical detector converts photons into electrical pulses and sends the electrical pulses to the acquisition (electronics) system 18.

For each detector array 42A-42N, the acquisition (electronics) system 18 includes one or more analog to digital converters 47A-47N and one or more digital storage devices 48A-48N that can provide a plurality of detector channels (e.g., 16, 32, 48 or 64 channels) of spectral data signals. The spectral data signals can be signal processed (e.g., digitized by the A/Ds) and time stamped, and packeted together by a packetizer 52 into a data packet corresponding to each cell/particle in the sample). These data packets for each cell/particle can be sent by the acquisition (electronics) system 18 to the analysis system 20 for further signal processing (e.g., converted/transformed from time domain to wavelength domain) and overall analysis. Alternatively, or conjunctively, time stamped digital spectral data signals from each channel that is detected can be directly sent to the analysis system 20 for signal processing.

The analysis system 20 includes a processor, memory, and data storage to store the data packets of time stamped digital spectral data associated with the detected cells/particles in the sample. The analysis system 20 further includes software with instructions executed by the processor to convert/transform data from the time domain to data in a wavelength/frequency domain and stitch/merge data together to provide an overall spectrum for the cell/particle/dyes excited by the different lasers and sensed by the detector arrays. With detection of the type of cell/particle through the one or more fluorescent dyes attached thereto, a count of the cells/particles can be made in a sample processed by a flow cytometer and/or cell sorter.

In some cases, it is desirable to sort out the cells in a sample for further analysis with a cell sorter (sorting flow cytometer). Accordingly, the spectral data signals can also be processed by a real time sort controller 50 in the acquisition (electronics) system 18 and used to control a sorting system 33 to sort cells or particles into one or more test tubes 34. In which case, the sorting system 33 is in communication with the real time sort controller 50 of the acquisition (electronics) system 18 to receive control signals. Instead of test tubes 34, the spectral data signals can also be processed by the real time sort controller 50 of the acquisition (electronics) system 18 and used to control both the sorting system 33 and a droplet deposition system 29 to sort cells or particles into wells 35 of a moving capture tray/plate. In which case, both the droplet deposition system 29 and the sorting system 33 are in communication with the acquisition (electronics) system 18 to receive control signals. In an alternate embodiment, the analysis system 20 can generate these control signals from analyzing the spectral data signals in order to sort out different cells/molecules and control the sorting system 33 and the droplet deposition system 29 to capture the drops of samples with cells/particles into one or more wells 35 of the plurality of wells in the capture tray/plate.

U.S. patent application Ser. No. 15/659,610 titled COMPACT DETECTION MODULE FOR FLOW CYTOMETERS filed by Ming Yan et al. on Jul. 25, 2017; and U.S. patent application Ser. No. 15/942,430 titled COMPACT MULTI-COLOR FLOW CYTOMETER HAVING COMPACT DETECTION MODULE filed by Ming Yan et al. on Mar. 30, 2018, each of which disclose exemplary flow cytometer systems and subsystems, are both incorporated herein by reference for all intents and purposes.

Referring now to FIG. 1B, a top view of a conceptual diagram of an electro-optical detection subsystem in a flow cytometer or cell sorter is shown. One or more beams of laser light 102 is generated by one or more lasers 101 and directed along an optical axis 109 into an interrogation region of a cuvette 120 in the flow cell 100. A laser light and/or forward scattered light signal 112 is received by a forward scattered detector (not shown) along the optical axis 109. If no cell is present, the laser light is received by the forward scattered detector without any forward scatter light.

A plurality of moving cells 104 in a flowing sample fluid makes its way by a flow channel into the interrogation region of the cuvette 120 of the flow cell 100. One or more beams of laser light 102 strikes the moving cells thereby forming a fluorescence and a side scattered light signal 106A along a second optical axis 110. If no fluorochrome is attached to a marker of a moving biological cell, a side scatter light signal may be all that is formed in the fluorescence and side scattered light signal 106A. Some biological cells autofluorescence when excited by laser light so there may be some autofluorescence light included in the fluorescence and a side scattered light signal 106A regardless of any fluorochrome being attached.

Generally, objective optical elements (objective lens) 128 collects the fluorescence and side scattered light signal 106A that is directed towards its front face along a second optical axis 110 that is on an angle (e.g., ninety degree angle or perpendicular) with the first optical axis 109. Accordingly, the objective optical elements (objective lens) 128 is designed and optimized to process the full wavelength bandwidth in the fluorescence and side scattered light signal 106A.

The objective lens 128 magnifies the image of the cell and focuses it as a focused fluorescence and side scattered light signal 106B down to an input end 151 of an optical fiber (or fiber bundle made up of a plurality of optical fibers) 150. The objective lens 128 and a mount 155 are coupled to a base 140. The mount 155 is further coupled to the optical fiber (or fiber bundle) 150 near the input end to hold it in alignment with the second optical axis 110. In the case of multiple fibers of a fiber bundle, the mount 155 can hold the plurality of fibers vertically in alignment with respect to the base 140 with each input end in alignment with a plane through the axis 110.

In one case, the objective optical elements 128 provide ten times (10×) the magnification of the cell. Along the optical axis 110, a back focal length (BFL) distance from the back face of the lens 128 and the input end of the optical fiber 150 is selected for the lens to optimize the desired wavelength range (between a wavelength minimum (λmin) and a wavelength maximum (λmax) inclusive—choosing a midpoint for example) to detect in the fluorescence and side scattered light signal 106A. FIG. 1C illustrates a magnified view of the back focal length (BFL) distance between the back face of the lens 128 and the input end of the optical fiber 150. A mechanical mount 155 is used to maintain a distance between the end of the optical fiber 150 and the back face of the objective lens 128 but can be adjustable to allow for a minor change in back focal length distance.

The range of wavelengths in the focused fluorescence and side scattered light signal 106B have a chromatic focal shift 152 so different wavelengths are focused differently into the input end of the optical fiber 150. The short wavelength of light 106S in the focused fluorescence and side scattered light signal 106B is focused down into the fiber 150 closer to its input end 151. The long wavelength of light 106L in the focused fluorescence and side scattered light signal 106B is focused down further into the fiber 150 away from its input end 151. The middle wavelength of light 106M in the focused fluorescence and side scattered light signal 106B is focused between the short and long wavelengths down into the fiber 150 away from its input end 151.

In the case of the system shown in FIG. 1B with the full bandwidth of light being collected by the optical fiber 150, the position of the input end 151 and the diameter of the optical fiber 150 or fiber bundle (plurality of optical fibers) are set to compromised values in order to receive the entire wavelength range between a wavelength minimum (λmin) and a wavelength maximum (λmax).

Referring now to FIG. 1D, a chromatic focal shift chart for an objective lens 128 is shown for the system of FIG. 1B. In the case of the system shown in FIG. 1B, the full bandwidth of light is to be collected by the optical fiber 150 from the short wavelength of light 106S to the long wavelength of light 106L in the focused fluorescence and side scattered light signal 106B. The Y axis in the chart indicates the wavelength of light in microns. The X axis in the chart indicates the chromatic focal length shift into an optical fiber from a given center point. With a shorter wavelength of light (e.g., 0.38 microns or 380 nanometers), there is about a negative 380 micron shift in chromatic focal length. With a longer wavelength of light (e.g., 0.90 microns or 900 nanometers), there is a positive 380 micron shift in focal length. Accordingly, over the entire bandwidth there is about a 760 micron (0.76 mm) shift in chromatic focal length. This is a relatively large chromatic shift and can result in poor performance nearer the ends of the wavelength bandwidth of light. Thus, the diameter of the one or more optical fibers 150 (a fiber bundle 150 if a plurality of optical fibers) and the position of its end should be chosen carefully to assure the input fiber 150 can receive the wavelengths over the entire range of the desired bandwidth. It is desirable to reduce the chromatic focal length shift into an optical fiber so that more efficient collection of light can be made with reduced requirements of the diameter and position of the end of an optical fiber.

The fluorescence light signal in the fluorescent and side scatter light signal 106B can have a wide range of wavelengths (λmin to λmax). The side scatter light signal has a wavelength equal to the wavelength of the laser light, which is generally also the wavelength minimum of a detection range (λmin). Autofluorescence from a biological cell can have various wavelengths of light but is usually above the excitation wavelengths from the laser light of the lasers. It is desirable that the coupling optics (objective, fiber, etcetera) and detector support the full bandwidth of wavelengths expected in the fluorescence and side scatter light signal 106B.

Recently, it has become desirable to implement flow cytometers with ultraviolet lasers and infra-red lasers to excite associated fluorochromes that mark or stain cells. Accordingly, a larger wavelength bandwidth in fluorescence is desirable to detect from fluorochromes being excited by the ultraviolet lasers and the infra-red lasers in order to perform more complex analysis of biological cells in a single pass. With a larger wavelength bandwidth, it becomes a greater challenge to overcome the chromatic effects in such broadband systems when using an optical fiber or fiber bundle to receive and redirect light. To efficiently couple a large bandwidth fluorescence and side scattered light signal 106B into the fiber 150, it is desirable for the objective lens 128 to make a small spot at the same location for all wavelengths of light that are to be detected. However, it is not physically possible for all to be focused at the same spot location, as shown by FIG. 1D. If the expected full spectrum of wavelengths of light are divided up into multiple wavelength ranges and multiple fibers are used, a distance of the end of each fiber for BFL and each fiber diameter can be selected so that all wavelengths in the greater bandwidth are better received by the input end of each fiber 150 for its respective wavelength ranges (bandwidth). Anti-reflective coatings can also be chosen for the ends of each optical fiber 150 to support broader bandwidths and/or optimize it to the selected bandwidths within the broader wavelength range.

The input end of the optical fiber 150 receives the focused fluorescence and side scattered light signal 106B optimized for the desired wavelength range. The optical fiber 150 redirects and launches the fluorescence and side scattered light signal 106B out of the opposite end into an array detector 160 in the flow cytometer/cell sorter system. Details of an example detector array at the opposite end of the optical fiber 150, are shown and described in U.S. patent Ser. No. 11/029,243 titled COMPACT DETECTION MODULE FOR FLOW CYTOMETERS, issued on Jun. 8, 2021, to inventors Ming Yan et al., incorporated herein for all intents and purposes.

In the case of the system shown in FIG. 1B, it is desirable that the fiber 150 and optical components inside the array detector 160 support the full bandwidth range of wavelengths in the light spectrum (e.g., 320 nanometer to 590 nanometer) that it is desirable to detect.

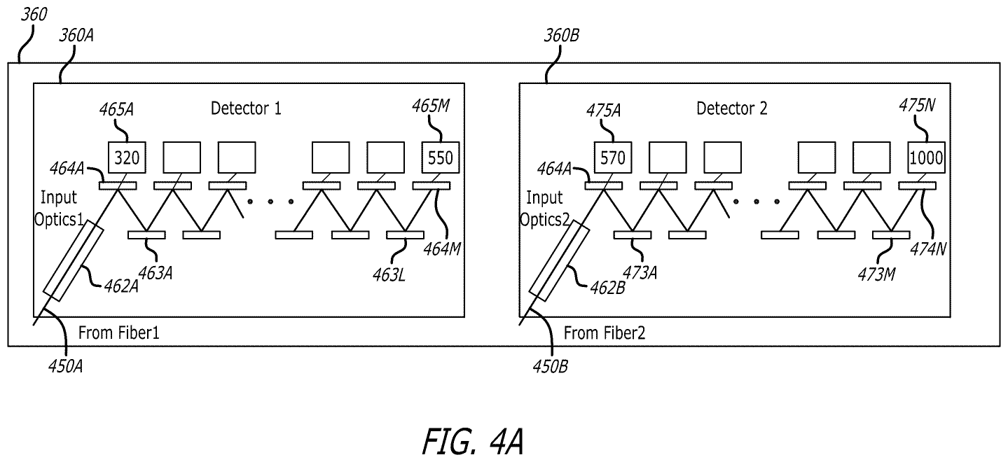

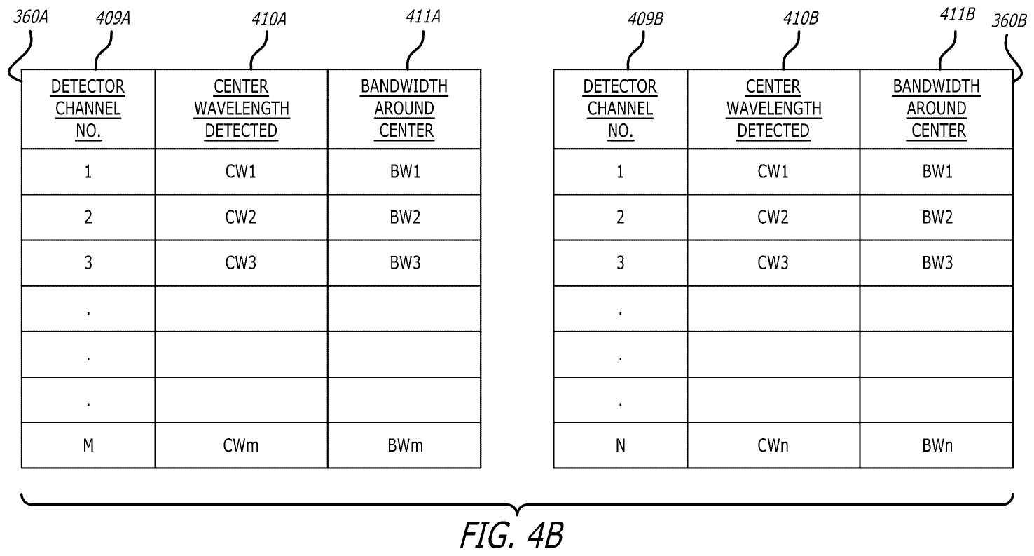

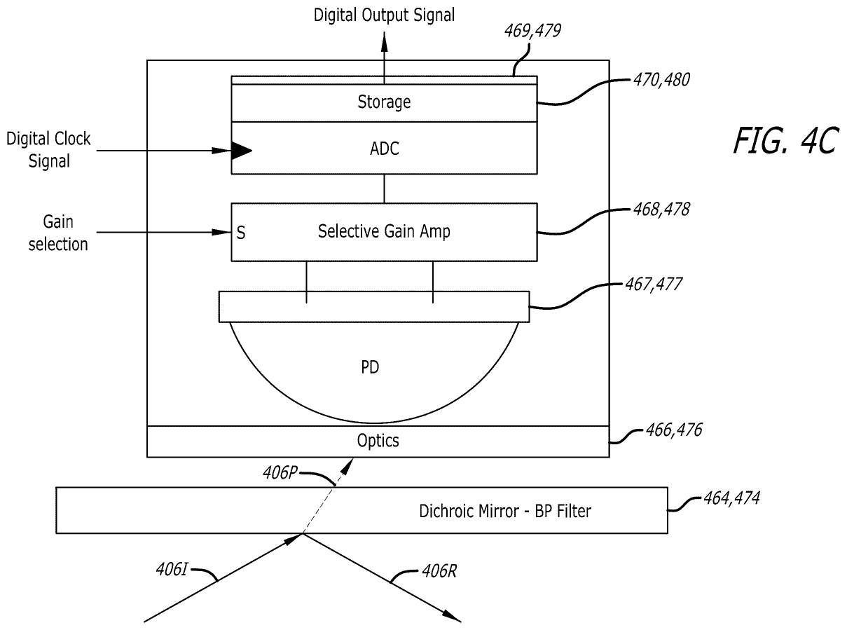

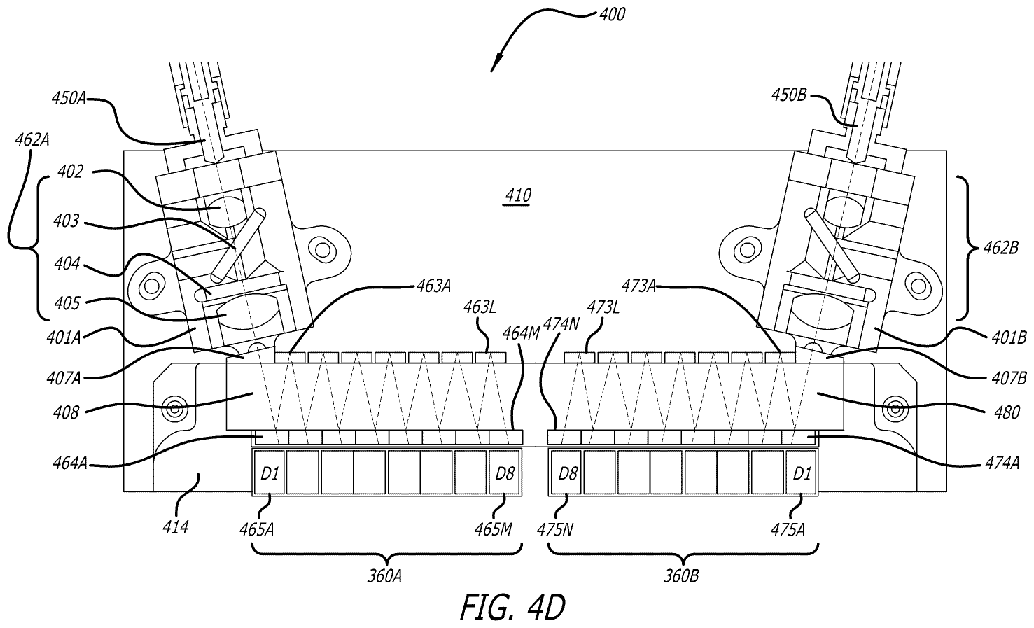

Referring now to FIG. 1E, an example array detector 160 is shown. The example array detector 160 is a linear array detector (photodiode array detector) with detector channels and photo detectors spatially aligned up in a row. The focused fluorescence and side scattered light signal 106B is launched out of the fiber 150 and coupled into the input beam shaping optics 162 of the array detector 160. The array detector 160 includes a plurality of M micromirrors 163A-163M, a plurality of N bandpass filters 164A-164N, and a plurality of N detector channels D1 through Dn 165A-165N. As shown in FIG. 4C, each detector channel D1 through Dn includes a photo detector 466,477; an adjustable or selectable gain amplifier 468,478; and an analog to digital converter (ADC) 470,480 coupled in series together. The photo detector 467,477 in the linear array detectors (photodiode array detectors) can be either a PIN photodiode or an avalanche photodiode (APD). The adjustable or selectable gain amplifier 468,478 allows for tuning the gain of each detector channel to compensate for noise, such as from excessive spillover for example. The plurality of M micromirrors 163A-163M can be a flat mirror, a curved mirror, or a spherical mirror. In one embodiment, the plurality of M micromirrors 163A-163M are spherical mirrors are curved to have a one half focal length so that an image is formed on the optical filter of every other detector channel, the odd detector channels after the first detector channel.

Further details of the example array detector are described in U.S. patent application Ser. No. 15/659,610 filed on Oct. 5, 2017, by inventors Ming Yan, et al., entitled COMPACT DETECTION MODULE FOR FLOW CYTOMETERS, and U.S. patent application Ser. No. 15/942,430 filed on Mar. 30, 2018, by inventors Ming Yan, et al., entitled COMPACT MULTI-COLOR FLOW CYTOMETER HAVING COMPACT DETECTION MODULE, both of which are incorporated herein by reference for all intents and purposes.

The input beam shaping optics 162 is used to collect fluorescence and side scattered light signal 106B from an optical fiber and send the various wavelengths on their way to different detector channels with proper beam conditions. From the input beam shaping optics 162, the shaped fluorescence and side scattered light signal 166 is reflected down and between the linear row between respective bandpass filters 164A-164N and micromirrors 163A-163M as shown. Depending upon the bandpass filter, a discrete wavelength portion of the shaped fluorescence and side scattered light signal 166 is coupled into each photo detector in each respective detector channel. Towards the last detector channels Dm and Dn, the intensity of the shaped fluorescence and side scattered light signal 166 can drop off making it more difficult for the selected wavelengths chosen by the bandpass filters 164M,164N to be detected. Increasing the number of detector channels in a row (e.g., to 24 detector channels) to accommodate a wider wavelength bandwidth can be problematic for the signal to noise ratio in the last few detector channels. In some cases, a last detector channel Dn 165N can be used to detect the side scatter light formed by the laser wavelength because it is less likely to need much detailed analysis.

Referring now to FIG. 1F, a chart of the characteristics of standard antireflective (AR) coatings is shown for an angle of incidence of 8 degrees with the X axis indicating wavelengths and Y axis indicating reflectance percentages. It is desirable that the objective lens 128, as well as the input optics 162 and the detector optics (including bandpass filters (e.g., 164A-164D) and dichroic mirrors (e.g., 163A-163D) in the first few passes of the array detector 160 cover the full bandwidth from a wavelength minimum (λ min) to a wavelength maximum (λ max). That is, the design and manufacture of the optics (especially optical coatings) of the input optics 162 and the first few columns of detector channels in the detector array are desirable to cover the full bandwidth. The later detector channels down the chain cover a narrower bandwidth range as the first few detector channels take away some portions of the full bandwidth that is to be detected. However, as shown in FIG. 1F, the performance of standard AR coatings 171-175 need improvement for a larger wavelength bandwidth such as from 320 nm to 1000 nm. AR coating A 171 has an average reflection percentage (Ravg) of less than 0.5 percent over a bandwidth of 350 nm to 700 nm. AR coating AB 172 has an average reflection percentage (Ravg) of less than 1 percent over a bandwidth of 400 nm to 1100 nm. AR coating B 173 has an average reflection percentage (Ravg) of less than 0.5 percent over a bandwidth of 650 nm to 1050 nm. AR coating C 174 has an average reflection percentage (Ravg) of less than 0.5 percent over a bandwidth of 1050 nm to 1700 nm. AR coating D 175 has an average reflection percentage (Ravg) of less than 1 percent over a bandwidth of 1650-3000 nm. In general, the reflection percentage (Ravg) is higher for broader bandwidth AR coatings.

It is desirable to apply anti-reflective coatings on some of the optics in a flow cytometer that are optimized to cover all wavelengths to be measured, such as from 320 nm to 1000 nm. For example, the objective optical elements (objective lens) 128 is designed and optimized to process the full wavelength bandwidth in the fluorescence and side scattered light signal 106A. Accordingly, it is desirable to have an antireflective coating that can be applied to the objective lens 128 to cover the full wavelength bandwidth in order to improve optical efficiency.

A new broadband AR coating for wavelength ranges from 300 nm to 1000 nm has been developed with different reflectance/transmission performance over the full range by combining more than two standard coatings together (e.g., coatings A, B, C together). For example, the new broadband AR coating has a lower bandwidth average reflection percentage (Ravg) of less than 2 percent over the wavelength bandwidth between 330 nm to 400 nm, a middle bandwidth average reflection percentage (Ravg) of less than 1.5 percent over the wavelength bandwidth between 400 nm to 860 nm; and an upper bandwidth average reflection percentage (Ravg) of less than 2.0 percent over the wavelength bandwidth between 860 nm to 1000 nm. Some transmission performance was sacrificed (Ravg from 0.5% to 1.5 or 2%) to have an antireflective coating with a broader wavelength range.

The standard industrial coating cannot give good performance in such a big range. For conventional flow cytometers, an AB combined AR coating 172 has an average reflection percentage (Ravg) of less than 1 percent over a bandwidth of 400 nm to 1100 nm and may be sufficient, even though its reflectance is increased to 1 percent from 0.5 percent. However, the wavelength range is insufficient for broadband flow cytometers having a bandwidth range that extends beyond, such as from 320 nm to 1000 nm. A new custom anti-reflection coating that combines more than two (three or more) anti-reflective coatings has been developed to cover the full bandwidth from 320 nm to 1000 nm. The objective lens 128 near the flow cell is to coated with the new combined antireflective coating formed out of the three or more antireflective coatings in order to support the full bandwidth range of light. The optics in the input channel of each array detector as well as mirrors and optical filters for first through third detection channels of each array detector can be coated with an antireflective coating based on the respective wavelength range of light that is detected by the respective array detector. Accordingly, the cost of components for the first few detector channels, mirrors, and bandpass filters with the new custom anti-reflection coating are likely to be greater than in a more conventional system. Antireflective coatings can also be selected and applied to ends of optical fibers for the bandwidth range that they are expected to carry to improve optical efficiencies.

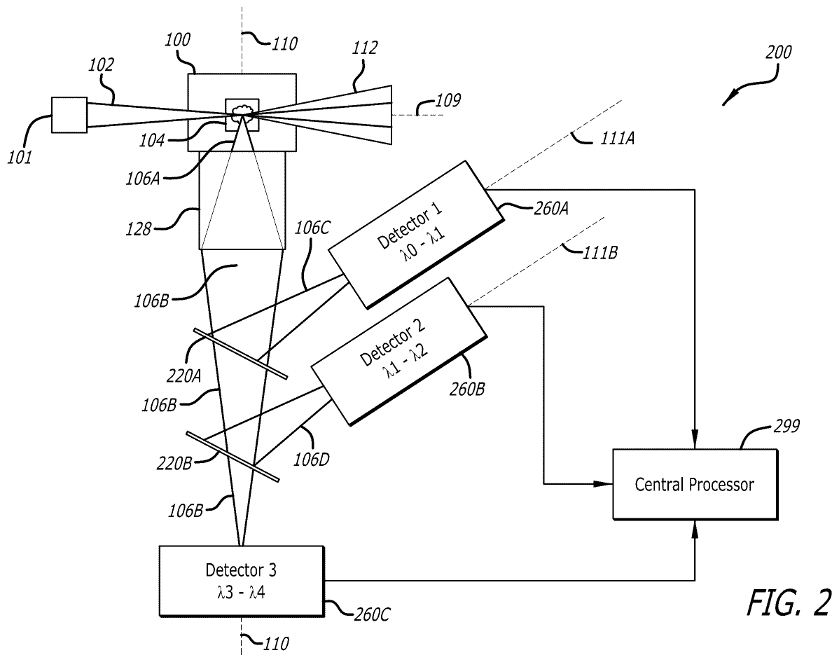

Referring now to FIG. 2, in order to improve detection for a higher bandwidth, the objective output (side scatter and fluorescence light signal 106B) from the objective lens 128 can be split out two or more light beams. Generally, an electro-optic subsystem 200 can include one or more coupling devices (such as beam splitters or dichroic mirrors or optical fiber) to take a portion of the bandwidth or a portion of the light intensity and redirect it into other detectors so that a plurality of detectors associated with all lasers are used to detect the full bandwidth.

In FIG. 2, one or more lasers 101 are used to generate one or more laser beams 102. The one or more laser beams are used to excite the different fluorochromes into the different wavelength bands when striking moving biological cells in the interrogation region of the transparent cuvette 102 of the flow cell 100 to form the side scattered and fluorescent light signals 106A as well as the forward scatter light and laser light 112. A plurality of detectors 260A-260C are used to detect the larger full bandwidth instead of trying to use a single detector. The spectral results from each of the plurality of detectors 260A-260C are being fused back together by a central processor 299 executing firmware instructions in order to represent spectral results of the full bandwidth.

In accordance with one embodiment, an electro-optical subsystem 200 in a flow cytometer is shown. The electro-optical detection subsystem 200 includes the objective lens 128, one or more beam splitters 220A-220B, a plurality of array detectors 260A-260C, and a processor 299. The objective lens 128 collects the side scattered light signals and fluorescent light signals 106A when the moving cell and its fluorochromes are struck by the various laser beams 102. The objective lens 128 focuses the side scattered light signals and fluorescent light signals 106A into the array detector 260C as a focused side scattered light signals and fluorescent light signals 106B with the full bandwidth (e.g., λ0 through λ4).

The one or more beam splitters (or dichroic mirrors) 220A-220B split the output 106B from the objective lens 128 into two or more beams 106C-106D while the output 106B continues into the array detector 206C. Each of the two or more beams 106C-160D is coupled into different array detector assemblies 260A-260B respectively. The beam splitter (or dichroic mirror) 220A further redirects the beam of the side scattered light signals and fluorescent light signal 106C in a first wavelength range along an optical axis 111A into the array detector 260A. The beam splitter (or dichroic mirror) 220B further redirects the beam of the side scattered light signals and fluorescent light signal 106D in a second wavelength range along an optical axis 111B into the array detector 260B. A remainder of the beam 106B in a third wavelength range passes through the one or more beam splitters (or dichroic mirrors) into the array detector 206C. Each detector assembly 260A-260C processes a part of the side scattered light signals and fluorescent light signal 106B with different wavelength ranges. The different wavelength ranges split off into the detector assemblies 260A-260B is smaller than the original wavelength range of the side scattered light signals and fluorescent light signal 106B output from the lens 128.

The coupling optics in the detector assemblies can be lenses, fibers, gratings (Bragg gratings), dichroic mirrors, or other types of optics. Different optical devices can be chosen for each detector assembly to resolve and detect the wavelengths of light that it receives. For example, gratings can be used in array detector 260A, filters can be used in detector 260B, and prisms can be used in detector 260C for example.

Each array detector assembly 260A-260C generates digital signals for the respective wavelength ranges they are to detect. The digital signals can be combined in a processor to give the response for whole wavelength range in the side scattered light signals and fluorescent light signal 106B. The processor 299 and digital to analog converters in the array detectors can be synchronized to the same clock signal and to the given event of cell detection. The processor 299 executes instructions to combine results together from the plurality of array detectors 260A-260C. The separate spectral results from each array detector are aligned together in accordance with the wavelength bandwidth each array detector receives.

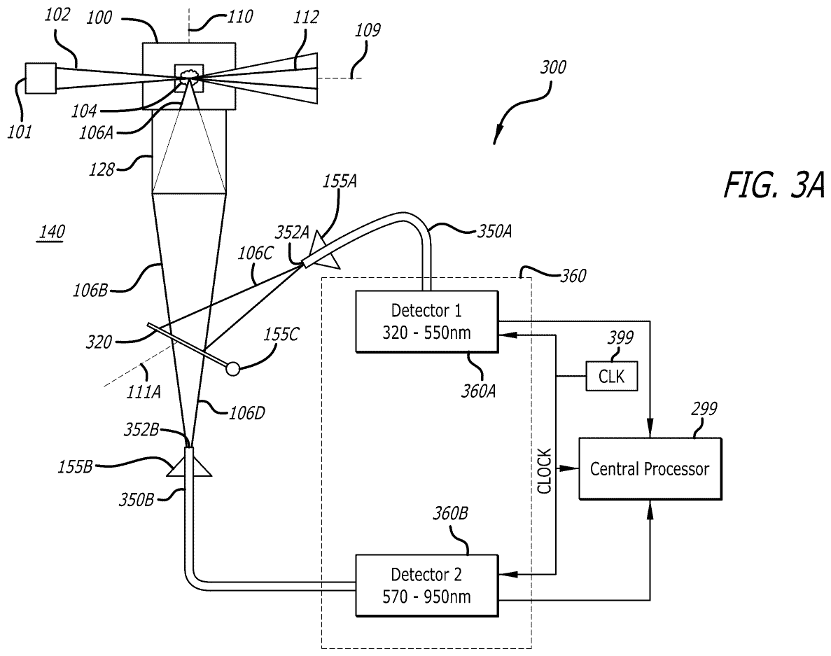

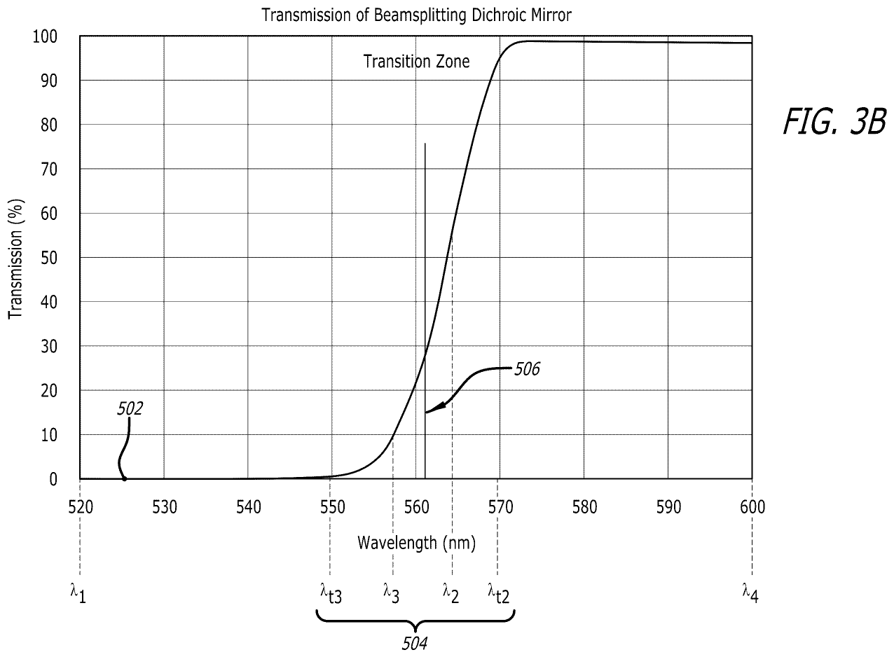

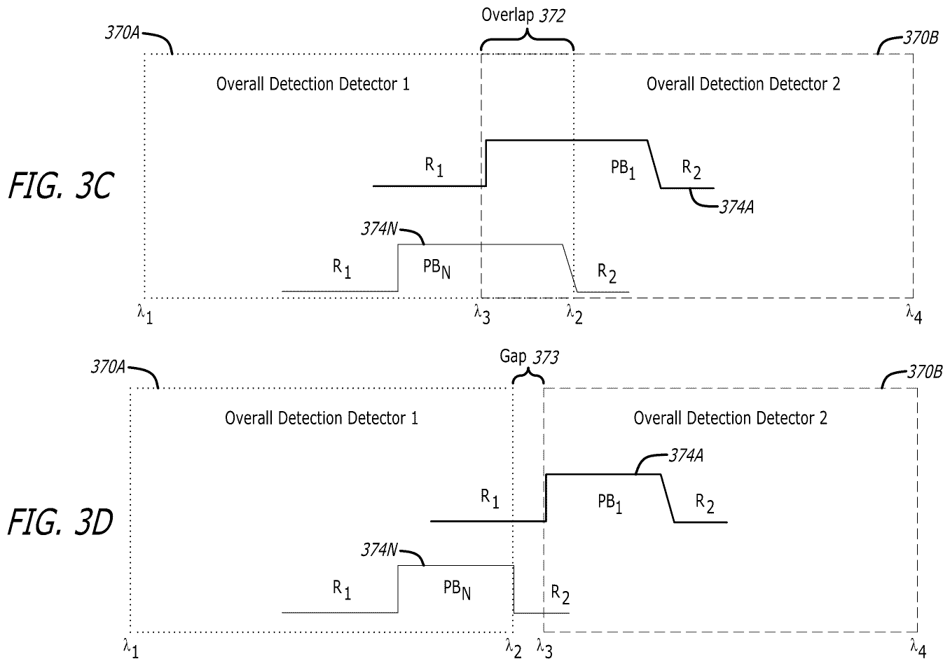

Spectral results from array detector 260A that receives the lower bandwidth of wavelengths (such as from λ0 through λ1) are first along the spectrum of results. Spectral results from the next array detector 260B can receive the middle bandwidth of wavelengths (such as from λ1 through λ2) providing the next spectral results along the spectrum. Spectral results from array detector 260C that receives the upper bandwidth of wavelengths (such as from λ3 through λ4) can be the final spectral results along the spectrum. There can be gaps in wavelengths of light (e.g., see FIG. 3D) that are to be detected by adjacent detectors in the spectral results to avoid undesirable light signals, such as from a laser. There can also be overlapping wavelengths of light (e.g., see FIG. 3C) between adjacent detectors, such as from a transition wavelength range that is a characteristic of the splitting optics. Regardless, the spectral results from the array detectors are in a digital form so it is relatively easy for the processor 299 to align them up along the wavelength spectrum.

Referring momentarily now to FIG. 3B, a chart of transmission characteristics 502 of an example beam splitting dichroic mirror are shown. The wavelength range that are transmitted (e.g., above λt2) and the wavelength range that are reflected (e.g., below λt1) can be changed by the design of the beam splitting dichroic mirror. In the transmission characteristics 502 of a beam splitting dichroic mirror there is often a transition zone 504 having a wavelength range (λt1 through λt2) for the splitting optics (e.g., beam splitter or dichroic mirror) that splits up light signals into the separate different wavelength bandwidths. The transition zone 504 is often around a center wavelength 506 of a laser that can be ignored by the detectors. However, the transition zone 504 can lead to overlapping wavelengths of light between adjacent detectors. For example, there can be overlapping wavelengths between the wavelength range of from λ1 through λ2 and λ3 through λ4, where the wavelength λ2 is greater than the wavelength λ3 as shown in FIG. 3B (see also FIG. 3C). In this case the wavelengths in the transition wavelength range between λ2 and λ3 can appear in both array detector 260B and array detector 260C with partial intensity. The splitting wavelength 506 can be arranged at a laser wavelength that need not be detected, such as the center wavelengths of the lasers 101 that generate the laser light 102. Occasionally there can be gaps between the wavelengths (such as between wavelengths λ2 and λ3, where λ2 is smaller than λ3-see FIG. 3D). Regardless, the spectral results from the array detectors are digital so that it is relatively easy for the processor 299 to be programmed to address overlapping wavelengths between detectors and gaps in wavelengths between detectors in order to align the results all together along the spectrum of light.

Referring now back to FIG. 2 and the electro-optical subsystem 200, the spectral range of flow cytometers can be expanded into the ultraviolet (UV) and near infrared (NIR) wavelength ranges. It is very difficult to have optics cover such a large wavelength range that includes visible, UV and NIR wavelength ranges. The disclosed embodiments provide a way to split a large wavelength range (spectral range) into several smaller wavelength ranges and have them processed in parallel by several different detector assemblies. By splitting up the wavelength ranges, good spectral performance can be achieved over a larger wavelength range.

Referring now to FIG. 3A, an electro-optic subsystem 300 is shown that uses one or more dichroic mirrors 320 and a plurality of different optical fibers (or fiber bundles of a plurality) 350A-350B as coupling devices into the plurality of array detectors (light detecting devices) 360A-360B. The expanded range of wavelengths in the side scattered and fluorescent light signal 106B is split up into two or more ranges by one or more dichroic mirrors (beam splitters) 320 and coupled into the plurality of array detectors by the plurality of optical fibers 350A-350B. While only one dichroic mirror (beam splitter), two optical fibers, and two array detectors are shown in FIG. 3A, the electro-optic subsystem 300 can be expanded to include more dichroic mirrors, more optical fibers (or fiber bundles), and more array detectors to further divide up the expected spectrum into a plurality of wavelength ranges (bandwidths) for detection by a flow cytometer or cell sorter. The plane of the one or more dichroic mirrors (beam splitters) 320 are at a forty-five degree angle with the optical axis 110 to direct the reflected light along the optical axis 111A at a forty-five degree angle with the optical axis 110.

A mechanical mount 155B coupled to the optical fiber 350A is used to maintain a BFL distance between the input end of the optical fiber 350B and the back face of the objective lens 128 through the dichroic mirror 320 but can be adjustable to allow for a minor change in the back focal length distance. The objective lens 128 focuses the light into a spot on the input end of the optical fibre. In one embodiment, the spot size matches the core size of the optical fibers at the BFL distance. A mechanical mount 155A coupled to the optical fiber 350A is used to maintain a summed distance for BFL between the end of the optical fiber to the dichroic mirror 320 and from the dichroic mirror 320 to the back face of the objective lens 128 but can be adjustable to allow for a minor change in back focal length distance. A mechanical mount 155C is couped to the dichroic mirror 320 and a base 140 to maintain its position and angle with respect to the optical axis 110. The mechanical mounts 155A-155B are coupled to the base 140, such as an optical bench, along with the objective lens 128 to also maintain the optical fibers 350A-350B aligned with the respective optical axes 110,111A. The selection of the optical fiber 350A (e.g., core diameter) and its back focal length BFL distance can be optimized for a first sub-wavelength range, a subset of wavelengths of the overall wavelengths that are expected to be generated at the flow cell by lasers exciting fluorochromes, particles, and cells flowing through the flow cytometer. The back focal length BFL distance for the optical fiber 350B can be optimized for a second sub-wavelength range that is expected to be received that differs from the first sub-wavelength range. The anti-reflective coatings for the optical elements in the input and initial detector channels in the detector 360A as well as at least the input end of the optical fiber 350A can be selected based on the first sub-wavelength range that is expected to be received. The anti-reflective coatings for the optical elements in the input and initial detector channels in the detector 360B as well as at least the input end of the optical fiber 350B can be selected based on the second sub-wavelength range that is expected to be received.

In one aspect, the expanded wavelength range in the side scattered and fluorescent light signal 106B is from 320 nanometers (nm) to 1000 nanometers (nm). A single or first dichroic mirror 320 can be arranged along the optical axis 110 at an angle. FIG. 3B illustrates the exemplary transmission characteristics for the dichroic mirror 320. The first dichroic mirror 320 is a key element in the system 300. Like the objective lens, the first dichroic mirror 320 receives the whole spectral range (including the expanded wavelength range spectral range) of light in the side scattered and fluorescent light signal 106B and splits its wavelength range into two parts by transmission and reflection. By the natural characteristics in the design of a dichroic mirror, there is a transition zone 504 that allows the dichroic mirror to change from high reflection to high transmission (see FIG. 3B). The transition zone 504 can be arranged around a center wavelength of a laser such as shown by the laser line 506. The wavelength range (λt1 through λt2) in the transition zone 504 is usually not used by cytometers to avoid noise signal from the lasers. For example, in FIG. 3B the dichroic mirror has a transition zone 504 in its transmission characteristics 502 around a laser line 506, such as 561 nm. Light signals below a wavelength of λt1 (e.g., 550 nm) are reflected by the dichroic mirror into a first fiber for a first array detector. Light signals above a wavelength of λt2 (e.g., 570 nm) are transmitted by the dichroic mirror and received by other different fibers/detectors and beam splitters (dichroic mirrors). Light signals having wavelengths in the transition zone 504 from (λt1 through λt2) are partially reflected/transmitted by the dichroic mirror into both paths (both fibers). The optical filters in the detector arrays can provide a gap in spectrum to avoid detection of light in the transition zone by the detectors. Alternatively, the optical filters in the detector arrays can have some overlap so that all data is captured and the data at or around the laser line 506 in the transition zone 504 can just ignored by the processor if desired.

Referring now to FIG. 3C, a block diagram of optical filter characteristics of wavelength ranges of two split detectors with an overlapping wavelength portion is shown. The wavelength range of a linear array detector module is set by the series of optical filters (e.g., bandpass, low pass, high pass) 164A-164N for the detector channels in each. In the case of an optical bandpass filter, there are two rejection bands R1,R2 around a pass band PB of wavelengths of light in its transmission characteristics. The two rejection bands R1,R2 can be reflective or absorptive. In the series of bandpass optical filters in the linear array detector modules, the two rejection bands are reflective to reflect the rejected light onto the next optical filter in the series. In the transmission characteristics of the optical bandpass filter in the series, each can have a sharp rising edge to accurately capture a starting wavelength while a falling edge is more relaxed in slope and overlaps into the passband of next optical filter in the series. The overall transmission characteristics 370A,370B of the series of optical filters results in substantially continuous detection over the wavelength range λ1 to λ2 by a first detector module and substantially continuous detection over the wavelength range λ3 to λ4 by a second detector module.

In FIG. 3C, there is an overlapping wavelength range 372 between wavelength λ3 and wavelength λ2 (where the wavelength λ2 is greater than the wavelength λ3) in the spectrum of wavelengths of light for the overall transmission characteristics 370A-370B of the first and second detector modules 360A-360B, respectively, to be sure all spectrum data is captured between the adjacent detector modules. Data associated with a laser line can be ignored by the processor. A last optical filter in the first detector module has an optical filter transmission characteristic 374N in the overall transmission characteristic 370A. A first optical filter in the second or adjacent detector module has an optical filter transmission characteristic 374A in the overall transmission characteristic 370N. A wavelength portion 372 in the passband PB1 of the optical filter transmission characteristic 374A overlaps with the wavelength portion 372 in the passband PBN of the optical filter transmission characteristic 374N.

Referring now to FIG. 3D, a block diagram of filter characteristics of wavelength ranges of split detectors with a spectrum gap or a non-overlapping wavelength portion 373 is shown. The gap or non-overlapping wavelength range 373 is between wavelength λ2 and wavelength λ3 (where the wavelength λ2 is less than the wavelength λ3) in the spectrum of wavelengths of light for the overall transmission characteristics 370A-370B of the first and second detector modules 360A-360B, respectively. Typically, a laser line associated with the wavelength of an excitation laser is within the gap 373 so it can be ignored by the adjacent detector modules and their respective array detectors.

In FIG. 3D, a last optical filter in the first detector module has an optical filter transmission characteristic 374N in the overall transmission characteristic 370A. A first optical filter in the second or adjacent detector module has an optical filter transmission characteristic 374A in the overall transmission characteristic 370N. The passband PB1 of the optical filter transmission characteristic 374A does not overlap with the passband PBN of the optical filter transmission characteristic 374N. In the transmission characteristics of the optical bandpass filter in the series, each can have a sharp rising edge to accurately capture a starting wavelength. Typically, a falling edge of the transmission characteristics of each optical bandpass filter is more relaxed in slope and overlaps into the passband of next optical filter in the series. However, the falling edge of the passband PBN of the optical filter transmission characteristic 374N can also have a sharp falling edge to better define and reduce the wavelength range in the gap 373 around a laser line.

Referring back to FIG. 3A, in accordance with one embodiment, the dichroic mirror 320 splits off the wavelengths of 320 nanometers (nm) to 550 nanometers (nm) in the side scattered and fluorescent light signal 106B as a lower bandwidth light signal 106C. The lower bandwidth light signal 106C is redirected at an angle along an optical axis 111A with the optical axis 110 toward an input end 352A of the optical fiber 350A or an equivalent fiber bundle. The lower bandwidth light signal 106C is redirected and launched out of an opposite end of the fiber 350B into the array detector 360A.

The remaining wavelengths (570 nm to 1000 nm) in an upper bandwidth light signal 106D of the side scattered and fluorescent light signal 106B are allowed to pass through the dichroic mirror 320 and be coupled into an input end 352B of the optical fiber 350B or an equivalent fiber bundle. The upper bandwidth light signal 106D is redirected by the fiber 350B and launched out of its opposite end into the array detector 360B. If more dichroic mirrors, more optical fibers, and more array detectors are used, the wavelength range of light signals from 570 nm to 1000 nm can be further split up for separate analysis.

The light signals in wavelength ranges of transition zone 504 (e.g., 550 nm to 570 nm) are coupled into both fiber bundles with only partial intensities due to the transmission characteristics 502 of the dichroic mirror. The wavelength range in the transition zone 504 is designed not to be measured because it is close to the wavelength of the laser line 561 nm.

In a flow cytometer, the optical objective (e.g., a lens) 128 is used to collect the side scattered and fluorescent light signal 106A out of the transparent cuvette 120 of the flow cell along the optical axis 110. The optical objective (e.g., a lens) 128 focuses the side scattered and fluorescent light signal 106A into a small spot that is desirable to be coupled into the fibers 350A-350B at their respective input ends 352A-352B. Preferably the diameter of the small spot matches the fiber core diameter an optical fiber, but the various wavelengths in the signal 106A,106B make it difficult for all the wavelengths to work the same way, as is discussed herein with regards to a chromatic focal shift. This may be alleviated somewhat by splitting up the ranges of wavelengths of light to be detected and selecting different core diameters and different back focal length (BFL) distances for different optical fibers based on the range of wavelengths of light expected to be received.

As shown in FIG. 1C, different wavelengths are usually focused at different locations in the input end of the fiber. A single fiber is usually placed at a compromised location trying to collect as much as possible all wavelengths in the entire bandwidth. In the case shown in FIG. 3A, the objective light output 106B is split into two or more beams and coupled into two or more different optical fibers 350A-350B. It is easier to optimize the BFL distance of an end of each optical fiber to the output face of the objective lens 128 with the wavelength ranges being split up. For example, the position of the input end 352A of the fiber 350A can be optimized with the total distance to the output face of the lens 128 along the optical axis 111A and 110 to collect light in the wavelength range from 320 nm to 550 nm. The position of the input end 352B of the fiber 350B can be optimized with the total distance to the output face of the lens 128 along the optical axis 110 to collect light in the wavelength range from 570 nm to 1000 nm. The gap between 550 nm and 570 nm is due to a center laser beam wavelength of 561 nm that is desirous to be avoided. Additionally, the optics receiving the light after the objective lens 128 and mirror 320 can be tailored to the respective split wavelength ranges that they receive and further transmit for improved efficiency and lower costs.

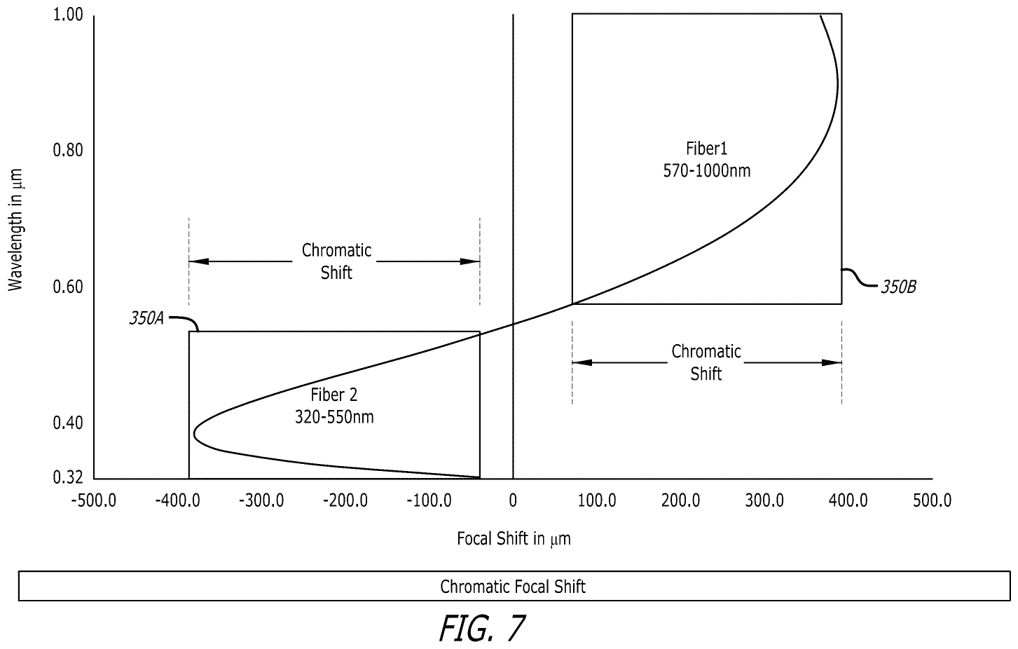

Referring momentarily to the chromatic focal shift chart in FIG. 7, the wavelength in microns is along the Y axis while the relative focal shift from zero is located along X axis. Fiber 350A supports wavelengths from 320 nm to 550 nm as indicated by the height of associated box with the width of the box being bound by max/min points on the curve in the wavelength range. For the fiber 350A there is a relative chromatic focal shift of about 0.35 mm. Fiber 350B supports wavelengths from 570 nm to 1000 nm as indicated by the height of associated box with the width of the box being bound by max/min points on the curve in the wavelength range. For the fiber 350B there is a relative chromatic focal shift of about 0.32 mm. FIG. 1D illustrated the chromatic focal shift chart for a single optical fiber 150. In FIG. 1D, the relative chromatic focal shift for a single optical fiber 150 was about 0.76 mm, significantly more than the relative chromatic focal shift of either of the optical fibers 350A-350B with the split wavelength ranges shown in FIG. 7. Accordingly, the two fiber configuration with the split wavelength ranges will provide a much better light coupling efficiency than a single fiber with a full bandwidth range of light.

Referring back to FIG. 3A, with the wavelength range of 320 nm to 550 nm in the side scattered and fluorescent light signal 106B spit off, redirected, and launched into the array detector 360A, the array detector 360A can be optimized to process this wavelength range of light signals. With the remaining wavelength range of 550 nm to 1000 nm in the side scattered and fluorescent light signal 106B allowed to pass, be redirected, and launched into the array detector 360B, the array detector 360B can be optimized to process this wavelength range of light signals. Not only can the array detectors 360A-360B be optimized for the respective wavelength range of light signals they receive, but the optical fibers 350A-350C can also be optimized for the respective wavelength range of light signals they will redirect and launch into the respective array detectors.

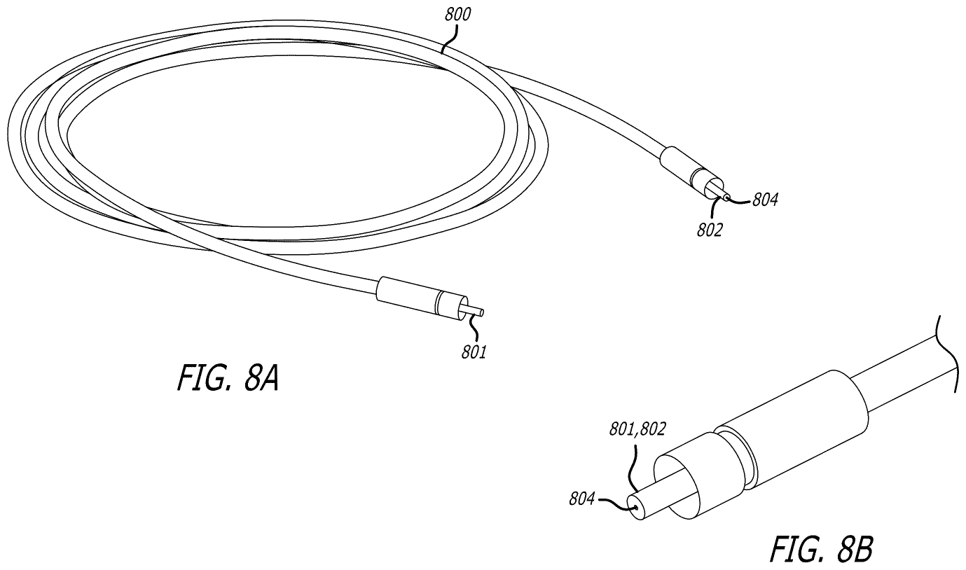

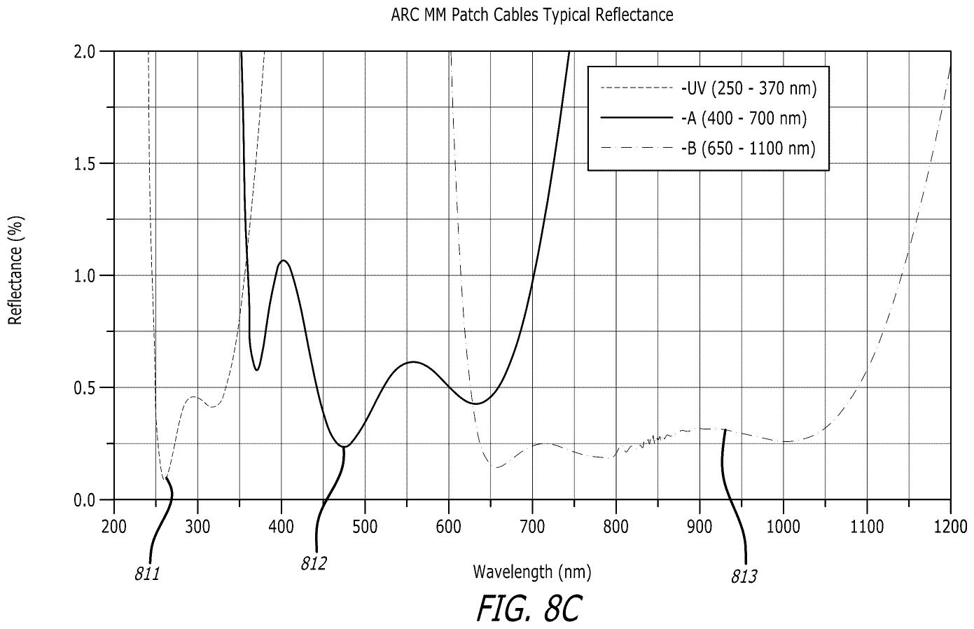

FIG. 8A illustrates an anti-reflective coated multimode fiber optic patch cable (fiber optic cable) 800 that can be customized and used for the optical fibers 350A-350B. The fiber optic cable 800 can be a THORLABS model M200L02S-B fiber optic cable, for example. The fiber optic cable 800 has an input end 801 and an output end 802 with connectors around them. FIG. 8B illustrates a magnified view of each end 801,801. The fiber optic cable 800 can have a multimode core 804 with various core diameters based on the expected operating wavelength range of the cable. For example, various core diameters can be 50 microns, 100 microns, or 200 microns can be selected for optimizing the collecting of a split off wavelength range of the side scattered and fluorescent light signal 106B. The input end 801 and the output end 802 of the fiber optic cable can also have various anti-reflective coatings based on the expected operating wavelength range of the cable.

In FIG. 8C, a chart of various anti reflective coatings (ARC) show different ranges of wavelength operation for the fiber optic cable 800. A first anti reflective coating 811 provides for optimizing an operating wavelength range between 250 nm-370 nm, for example. A second anti reflective coating 812 provides for optimizing an operating wavelength range between 400 nm-700 nm, for example. A third anti reflective coating 813 provides for optimizing an operating wavelength range between 650 nm-1100 nm, for example. Accordingly, the plurality of optical fibers 350A-350B used with the system 300 can each be customized by respective core diameter and anti-reflective coating to the desired split out wavelength ranges, such as 320 nm to 550 nm and 570 nm to 1000 nm, for example.

FIG. 4A illustrates a conceptual block diagram of two array detectors 360A-360B. The two array detectors 360A-360B can be packaged together in one package as a single dual array detector module 400 with two optical fiber inputs 450A-450B respectively coupling to two input channels with input optics 462A-462B. The array detector 360A in the package is optimized to process light signals in the range of wavelengths from 320 nm to 550 nm and the second array detector 360B in the package is optimized to process light signals in the range of wavelengths from 570 nm to 1000 nm. Accordingly, the optics and electro-optics (e.g., mirrors, bandpass filters, photo detectors) inside each array detector 360A-360B can be optimized to support its narrower bandwidth range of wavelengths. For example, input optics 462A, the dichroic mirrors 463A-463L, the bandpass filters 464A-464M, and the photo detectors in the detection channels 465A-465M of the array detector 360A can all be optimized for the bandwidth range of light from 320 nm to 550 nm. Similarly, the input optics 462B, the dichroic mirrors 473A-473M, the bandpass filters 474A-474N, and the photo detectors in the detection channels 475A-475N of the array detector 360B can all be optimized for the bandwidth range of light from 570 nm to 1000 nm. The plurality of dichroic micromirrors 463A-463L, 473A-473M can each be a flat mirror, a curved mirror, or a spherical mirror. In one embodiment, the plurality of dichroic micromirrors 463A-463L, 473A-473M are spherical mirrors that have a radius of curvature to have a one half focal length so that an image is formed on the optical filter of every other detector channel, the odd detector channels after the first detector channel.

Referring now to FIG. 4B, there may be different numbers of detection channels 409A,409B and photo detectors in the array detectors that 360A,360B that are packaged together for the different bandwidths of light that are supported. A center wavelength 410A,410B and a bandwidth 411A,411B around the center wavelength can be assigned to each photo detector in each detection channel number 409A,409B for the different bandwidths of light that are supported. The first center wavelength for a detector typically starts above a center wavelength of a laser light that excites fluorochromes. For a UV laser at 300 nm wavelength for example, a center wavelength of a first detector in the array can be set to 320 nm for example. The bandwidth 411A,411B around the center wavelength 410A,410B can differ for each detection channel 409A,409B. For example, bandwidth 411A,411B can be between a small number of wavelengths, such as 15 nm (plus and minus 7.5 nm), and a larger number of wavelengths, such as 34 nm (plus and minus 17 nm).

Additionally, the number of detectors for the different bandwidths of light that are supported can differ. For example, array detector 360A may have M detection channels 409A to support light over the range from 320 nm to 550 nm. Array detector 360B may have N detection channels 409B to support light over the range from 570 nm to 1000 nm. The bandwidth for each array detector can be different and the bandwidth around the center wavelength can be different such that the number N of detection channels is greater than M or the number M of detection channels is greater than N in the different array detectors.

With the different bandwidths of light supported by the array detectors, the optics used in each can differ and provide better performance at lower costs. The input optics 462A of the array detector 360A can be optimized to support light over the wavelength range from 320 nm to 550 nm. The input optics 462B of the array detector 360B can be optimized to support light over the wavelength range from 570 nm to 1000 nm. For example, the antireflective coating for each input optics can be optimized to support light over the respective wavelength range. The optics for each different photo detector in each different array detector can be optimized for the respective center wavelength and the respective bandwidth around the respective center wavelength along the chain of detector channels. For example, the antireflective coating for a respective photo detector can be optimized for its center wavelength and its bandwidth around the center wavelength. The bandpass filter in the earlier channels of a chain, such as bandpass filter 464A,474A for detector channel 1 in each array detector 360A,360B is optimized to support its respective bandwidth and reflects substantially more of the respective bandwidth than the bandpass filter 464M,474N in the respective last detector channel M,N in each array detector 360A,360B.

In the case each detector array 360A-360B is a linear photo detector array, it includes one or more input optical devices 462A-462B to receive light from one or more optical fibers, a plurality of detector channels 465A-465M,475A-475N; a plurality of micromirrors 463A-463L,473A-473M; and a plurality of optical filters 464A-464M,474A-474N. As shown in FIG. 4C, each detector channel 465A-465M (collectively 465),475A-475N (collectively 475) includes one of the plurality of filters 464,474; optics (e.g., lens) 466,476; photo detector (PD) 467,477; selectively adjustable gain amp 468,478; and an analog to digital converter (ADC) 469,479. The bandpass filter 464,474 receives an incident light beam 4061 on an angle along an incident optical axis. The bandpass filter 464,474 strips out or filters out a discrete wavelength range from the incident light beam 4061 and allows it to pass through as passed or filtered light 406P in the passband around a center wavelength. The passed or filtered light 406P with the discrete wavelength range is desired to be detected by the given photo detector 467,477. The bandpass filter 464,474 further reflects a reflected light 406R within the remaining wavelengths in the rejection bands out on an exit angle into the next mirror in the serial chain. The incident angle and the exit angle have similar (equivalent) angles with the plane of the bandpass filter 464,474.

The optics 466,476 focuses the filtered light 406P into the photodetector 467,477. The optics can be integrated with the photo detector 467,477. The photodetector 467,477 transduces the light 406P into analog electrical signals that are coupled into the selectively adjustable gain amplifier 468,478. The selectively adjustable gain amplifier 468,478 amplifies the analog electrical signal as needed to provide a better signal to noise ratio based on a gain selection signal. The amplified analog signal is coupled into the ADC 469,479. The ADC 469,479 is clocked by a clock signal and converts the amplified analog signal into a digital signal output for the given detection channel over a portion of a clock period (first phase on an edge) and then saves the digital signal during the next portion (second phase on opposite edge) of the clock period. The ADC may include a register, memory or other storage device 470,480 to hold one or more of the digital signals that are generated for the processor to collect into a larger storage device, such as a solid state storage device or a hard drive of a computer. The digital signal represents a discrete portion of the wavelength of light (e.g., 50 nanometers) around the center wavelength of the passband of the optical filter.

Each array detector 360A-360B generates a plurality of digital signals for the respective wavelength ranges they detect. Array detector 360A generates a first plurality of digital signals representing discrete portions of wavelengths over a first wavelength range. Array detector 360B generates a second plurality of digital signals representing discrete portions of wavelengths over a second wavelength range. If there are N detection channels in array detector 360A and M detection channels in array detector 360B, there are N plus M digital signals that can be combined by the processor 299 into a combined detected spectral signal for the whole wavelength (full bandwidth) range in the side scattered light signals and fluorescent light signal 106A,106B. A clock signal generator 399 can generate a clock signal coupled into the processor and the array detectors 360A-360B to provide a synchronized timing signal. The processor 299 and digital to analog converters in the array detectors can be synchronized to the same clock signal and time stamp the digital signals and an event number of cell detection so the signals can readily be aligned together for each cell detection event. The processor 299 executes instructions to combine results together from the plurality of array detectors 360A-360B. The separate spectral results from each array detector are aligned together in accordance with the respective wavelength bandwidth that each array detector receives for each event (excitation of fluorochrome/detection of a cell).

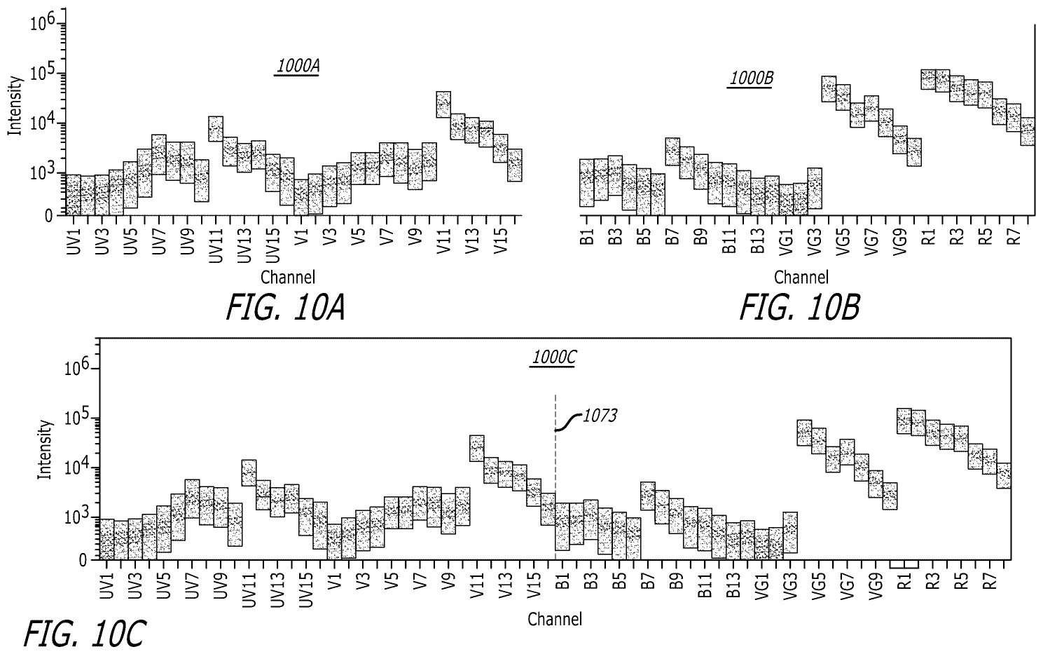

Referring now to FIGS. 10A-10C, a digital microprocessor or digital signal processor can be used thereafter to piece the results together from each of the various detector types for the full spectral response over the entire bandwidth range that is desired. FIG. 3A illustrates a central processor 299 that is used to piece the results together from each of the two linear detector arrays 360A,360B for a full spectral response over the entire bandwidth range that is desired. FIG. 2 illustrates a central processor 299 that is used to align and piece the results together from each of the three detector modules 260A,260B,260C for a full spectral response over the entire bandwidth range that is desired. Two or more detector modules with a series of a plurality of optical filters, a series of a plurality of mirrors and a series of a plurality of photo detectors (PMT, photodiode, or avalanche photodiode) may be used to detect and form a respective portion of the fluorescent spectrum (or auto-fluorescent spectrum) that is generated by an excited fluorochrome attached to a cell or a particle.

In FIG. 10A, a first fluorescence spectrum portion 1000A is detected and captured by a first linear detector array and its series of plurality of photo detectors, such as in the detector module 360A. In FIG. 10B, a second fluorescence spectrum portion 1000B is detected and captured by a second linear detector array and its series of plurality of photo detectors, such as in the detector module 360B. The central processor (signal processor) 299 (see FIG. 3A) is synchronized together with the detector modules 360A,360B by a clock signal that is generated by the clock signal generator 399 and coupled into each. The data generated by the detector modules 360A,360B can additionally be tagged with the same event number so the proper data can be merged and stitched together. Software instructions executed by the processor convert/transform data from the time domain to data in a wavelength/frequency domain for each detector module. The spectral data 1000A,1000B in the wavelength/frequency domain for each detector module can then be aligned based on wavelength and then stitched and merged together to provide an overall spectrum 1000C for the cell/particle/dyes excited by the different lasers and sensed by the detector arrays. Any overlap in spectrum between detector arrays due to the beam splitter can be aligned and stitched together with their respective intensities summed together to provide the overall detection in the overlapping spectrum. One or more laser gaps 1073 may be formed with the overall spectrum 1000C by removing data around center wavelengths of the two or more excitation lasers or otherwise formed by gaps between detector modules.

### Multiple Detectors Packaged Together

Referring now to FIG. 4D, a dual compact wavelength detection module 400 is shown. The dual compact wavelength detection module 400 includes dual array detectors 360A-360B that share a transparent optical block 480 in a detector module portion 414 mounted to a base 410. For the array detector 360A, light is received from a first optical fibre 450A and travels from left to right along the series of optical filters 464A-464M, the series of mirrors 463A-463L, and into the series of detector channels 465A-465M, respectively. For the array detector 360B, light is received from a second optical fibre 450B and travels from right to left along the series of optical filters 474A-474N, the series of mirrors 473A-473L, and into the series of detector channels 475A-475N, respectively. While dual 8 bit detector arrays are shown, other even combinations of detector channels (e.g., 2, 4, 6, 10, 12, 14) or other odd combinations of detector channels (e.g., 3, 5, 7, 9, 11, 13) that sum to the total photo detectors available in the package (e.g., 8, 16, 24, 32, 40, 48, 56, 64, 72, 80, 88, 96, etc.) can be used to form dual detector arrays for different wavelength bandwidths. One or more photo detectors in the package with optical filters to receive (allow transmission) of laser light at one or more center wavelengths can be used as side scatter detectors for one or more lasers.

The dual compact wavelength detection module 400 includes a first input stage (head or input channel) 401A, a second input stage 401B, and the detection module 414 mounted to the base 410 to maintain their alignment together. A first wavelength range of light from the flow cell is coupled into the first input stage (head or input channel) 401A by the optical fiber 450A. A second wavelength range of light from the flow cell is coupled into the second input stage (head or input channel) 401B by the optical fiber 450B. The first input stage (head or input channel) 401A includes the input optics 462A and the second input stage (head or input channel) 401B includes the input optics 462B. The input optics 462A-462B may be customized to best receive the respective wavelength of light from the respective optical fibers 450A-450B. Generally, each of input optics 462A-462B can include a collimating lens 402, a long pass filter 403, a cleanup optical blocker 404, and a focusing lens 405 mounted in a housing or optical bench of input stages (heads or input channels) 401A-401B. The input stages (heads or input channels) 401A-401B set up the magnification M1-M2 of the initial spot size image A(1) on the first optical filter 464A-474A for each array detector. The respective laser light is output from the input stages and coupled into the detection module 414 of the dual array detectors.

An end of each input stage (head or input channel) 401A-401B is coupled to respective transparent wedges 407A-407B to receive the respective laser light from the focusing lenses 605 of the input optics 462A-462B. The detection module 414 includes a dual if image array 408 for respective dual array detectors 360A-360B. The image array 408 includes the transparent block 480 with its wedges 407A-407B and micro-mirrors 463A-463L,473A-473L on one side. On an opposing side of the transparent block 480, there are the optical filters 464A-464M,474A-474N.

In accordance with one embodiment, the optical filters 464A-464M,474A-474N are bandpass optical filters with a transmission band having a pair of reflecting rejection bands around it. In another embodiment, the optical filters 464A-464M,474A-474N can be low pass optical filters with a transmission band and a reflecting rejection band. In another embodiment, the optical filters 464A-464M,474A-474N can be high pass optical filters with a transmission band and a reflecting rejection band.

The light that is coupled into the image array 408 by the first input stage 401A, is wavelength demultiplexed into the photo detectors in the detector channels 465A-465M. The light that is coupled into the dual if image array 408 by the second input stage 401B, is wavelength demultiplexed into the photo detectors in the detector channels 475A-475N. The dual detection module can analyze a pair of ranges of wavelengths of fluorescent light from the flow cell as well as side scatter light from one or more lasers.

A wavelength division demultiplexer in each linear array detector is formed by the optical block to receive light from at least one optical fiber; the plurality of optical filters aligned in a row on one side of the optical block to transmit differing discrete portions of light and reflect the remaining portion of light; and the plurality of micromirrors aligned in a row on an opposite side of the optical block to receive the reflected remaining portion of light from respective optical filters but for a last optical filter. The plurality of micromirrors reflect the remaining portion of light received from respective optical filters towards a respective next optical filter in the plurality of optical filters aligned in the row. The first optical filter in the series is somewhat unique in that it receive light directly from the at least one optical fiber through the optics in the head (input channel). The last optical filter in the series can be somewhat different in that it no longer needs to reflect light and instead can just absorb light in the rejection bands instead of reflecting light in the rejection bands. The plurality of photo detectors aligned in a row in series under the plurality of optical filters to respectively receive the differing discrete portions of light and transduce them into electrical signals.

The series of detector channels D1-D8 465A-465M in the array detector 360A includes a plurality of photo detectors (e.g. photo detector 466,467 of FIG. 4C) each having a lens (e.g., optics 466,474 of FIG. 4C) to focus the demultiplexed light into the photo detector. The series of detector channels D1-D8 475A-475N in the array detector 360B similarly includes a plurality of photo detectors (e.g. photo detector 466,467 of FIG. 4C) each having a lens (e.g., optics 466,474 of FIG. 4C) to focus the demultiplexed light into the photo detector. Each detector channel in the array detectors 360A-360B, further includes the adjustable or selectable gain amplifier 468,478; and the analog to digital converter (ADC) 469,479 coupled in series together with the photo detector 466,467 shown in FIG. 4C.

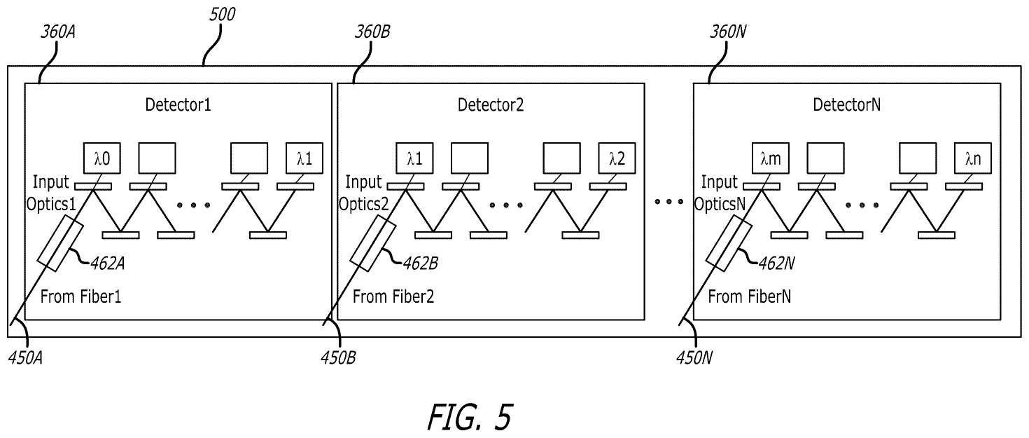

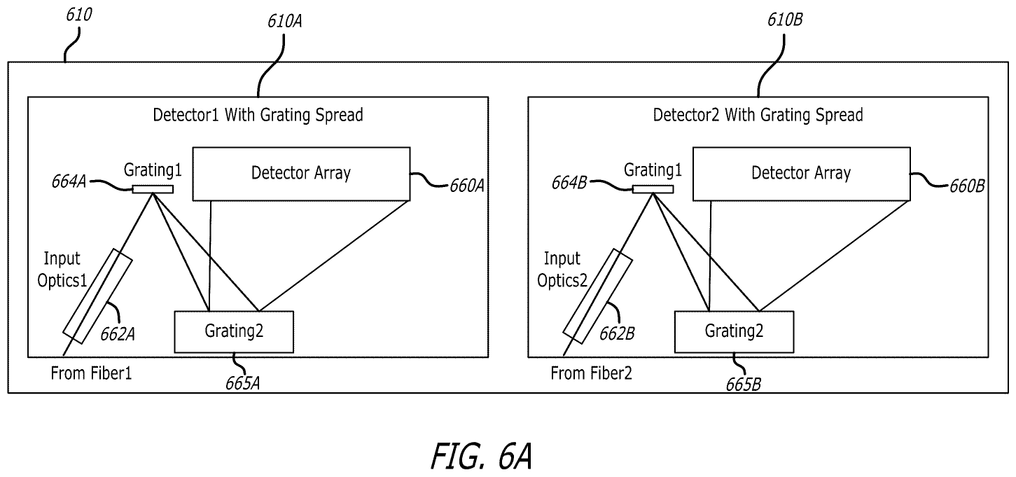

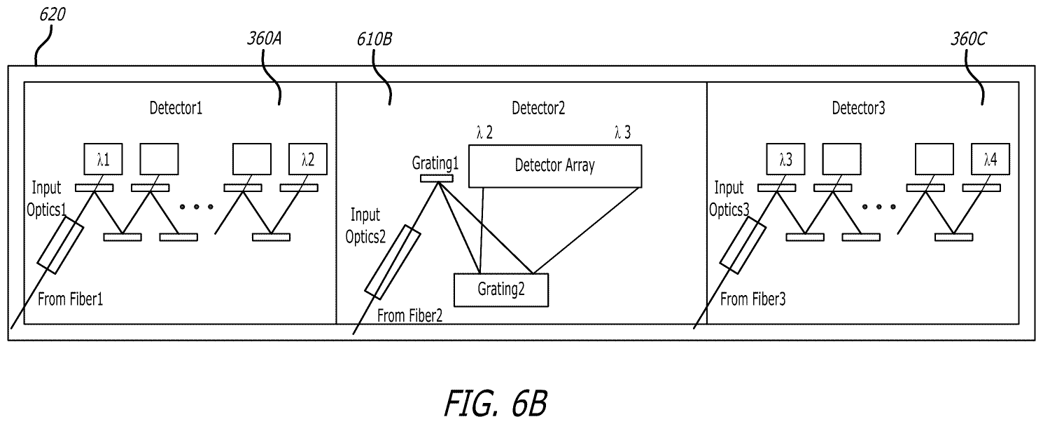

As shown in FIG. 4A and FIG. 4D, dual array detectors 360A-360B are packaged together in one package as a single array detector 360,400 with two optical fiber inputs 450A-450B. However, the overall bandwidth of the fluorescence and side scatter signal can be split up further into more than two paths and two signals. Accordingly, more than two array detectors can be used in a system such as shown in FIG. 5 and FIG. 6B. More than two array detectors can be aligned in a row together if space permits. Alternatively, pairs of two array detectors in a row may arranged vertically and packaged back to back (forward to forward, or back to forward), possibly sharing a base or optical plate with opposing sides to which the input channels and optical blocks mount, in order to provide three or four array detectors in a single compact package. Arranging the photo detectors together on one side of a package can simplify electrical connections. Arranging the optical connections on the opposite side of the photo detectors in the package (e.g., on the left and right side of the top side) can simplify the location of making optical connections. Furthermore, the location of cooling for avalanche photodiode photo detectors onto one side of a package can be centralized to further compact a flow cytometer. More than one package of multiple detector arrays can be provided in a flow cytometer with the supporting optical elements to achieve the desired efficiency improvements in detection of a full fluorescent light spectrum with increased bandwidth.

Referring now to FIG. 5, a plurality of N array detectors 360A-360N are shown packaged (integrated) together in an array detector 500 with N optical fiber inputs 450A-450N. Combining multiple detectors into a single integrated package can save space and costs over the use of separate packages for each detector. The plurality of N array detectors 360A-360N splits up the overall bandwidth range into N smaller different bandwidth ranges (sub-wavelength ranges or sub-bandwidths). With an overall bandwidth range from a wavelength of λ0 to a wavelength λn, the first array detector 360A detects a wavelength range from λ0 to λ1. The second array detector 360B detects a wavelength range from λ1 to λ2. The Nth array detector 360N detects a wavelength range from km to λn. Each of the N array detectors 360A-360N receiving the different wavelength ranges can have customized input optics 462A-462N to receive the launched signal from each optical fiber coupled to the N optical fiber inputs 450A-450N. Each optical fiber coupled to the N optical fiber inputs 450A-450N can be selected and input end coated with antireflective coating to be optically efficient for the respective different wavelength ranges being received and launched in the respective array detector.

The plurality of N array detectors 360A-360N combine to provide Z detector channels with Z photo detectors for the overall bandwidth range. For example, Z can be 24 detector channels with 24 photo detectors. The total number of detectors in each array detector can vary. For example, assume three array detectors 360A,360B,360C with a total of 24 detector channels. The first array detector 360A may have 10 detector channels, while the second array detector 360B and the third array detector 360C may have 6 detector channels each, for example. While details of 8 bit detector arrays are shown and described, other even combinations of detector channels (e.g., 2, 4, 6, 10, 12, 14) or other odd combinations of detector channels (e.g., 3, 5, 7, 9, 11, 13) that sum to the total photo detectors available in the package (e.g., 8, 16, 24, 32, 40, 48, 56, 64, 72, 80, 88, 96, etc.) can be used to form detector arrays for different wavelength bandwidths. Furthermore, the N array detectors 360A-360N in the package 500 can be of the same type, such as a linear array detector with photodiodes, mirrors, and dichroic mirror/filters lined up linearly in a row as shown. Other types of optics and detectors can be used as the array detectors in a system.

Referring now to FIG. 6A, a pair of grating based array detectors 610A-610B are shown that can be packaged together one into a packaged grating detector 610. The pair of grating based array detectors 610A-610B can be substituted for the pair of array detectors 360A-360B in FIG. 3A for example. Each grating based array detector 610A-610B includes input optics 662A-662B, a first grating 664A-664B, a second grating 665A-665B, and a detector array 660A-660B. Each detector array 660A-660B can be based on a photomultiplier tube (PMT) or a plurality of photo detectors in a row with differing optical filters.

The input optics 662A-662B focus the input light beam into a spot of the first grating 664A-664B along a first optical axis. The first grating 664A-664B reflects the light beam at an angle into a second optical axis and initially spreads out its wavelengths of light into a first spread light that is incident onto the second grating 665A-665B. Needing further wavelength spreading within a small package, the second grating 665A-665B receives the first spread light along the second optical axis and reflects it into a third optical axis and spreads its wavelengths of light further as a second spread light that is incident into the array detector 660A-660B.

A grating based array detector can give optimal results in certain wavelength ranges, such as from 494 nm to 844 nm for a given laser. Generally, grating based detectors have poor performance with light signals having a wavelength below 494 nm. However, different types of detectors can be used to detect light signals below 494 nm. For example, the first array detector in a package can be linear photo detector array for its respective bandwidth portion while the second array detector can be a grating-based type of detector for its respective bandwidth portion.

Referring now to FIG. 6B, different types of detectors can be used to achieve best performance in each wavelength band. FIG. 6B illustrates a diagram of a mixed array detector 620 packaged together. The detector 620 includes a first linear array detector 360A, a grating based array detector 610B, and a second linear array detector 360B packaged together with three fiber inputs. From a first beam splitter and a first fiber coupled into the first optical input, the first linear array detector 360A receives light in the lower wavelength range from λ1 to λ2. From a second beam splitter and a second fiber coupled into the second optical input, the grating based array detector 610B receives light in a middle wavelength range from λ2 to 3. From a third beam splitter and a third fiber coupled into the third optical input, the second linear array detector 360B receives light in the upper wavelength range from λ3 to λ4. In this manner the grating based detector 610B can be used in the middle wavelength range, such as from 500 nm to 800 nm for example, where it can be efficient; the first linear array detector 360A can be used in the lower wavelength range, such as from 300 nm-500 nm for example, where it can be efficient; and the second linear array detector 360B can be used in the upper wavelength range, such as from 800 nm-1000 nm for example, where it can be efficient.

A linear array detector as shown in FIGS. 4A and 5 with photo detectors and channels lined up linearly in a row can be used as the array detecting devices in a flow cytometer/cell sorter system. Alternatively, different types of detectors and different spatial arrangements of the detectors can be used in the system with one or more optical coupling devices to split up the light bandwidth that is detected and be subsequently merged together by a processor into the overall spectral response for the full bandwidth.

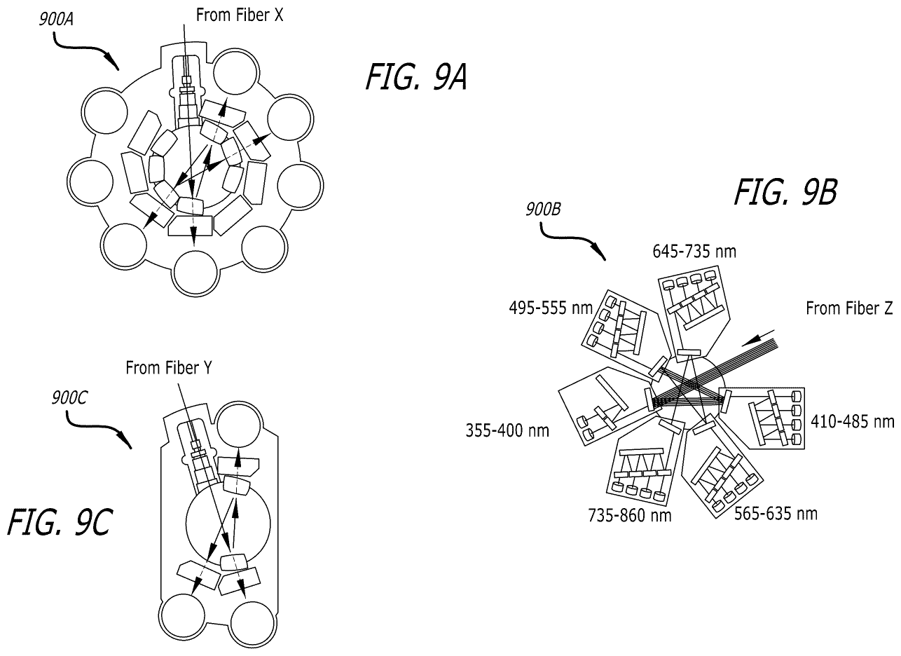

Referring now to FIGS. 9A-9C, the array detector type is not spatially limited to a linear array detector such as shown by FIGS. 4A and 5A-5B with a series of photo detectors aligned up in a row. With additional optical elements, other spatial arrangements can be made and utilized to split up the overall bandwidth into discrete parts and then assemble the results together with a processor if a broadband of wavelengths is desirable to be detected.

FIG. 9A illustrates an octagon spatial detector arrangement 900A of eight photo-multiplier tubes (PMT) each being supported by a long pass (LP) filter and a bandpass (BP) filter to select a passband for detection and reflect other bandwidths to the next PMT detector in the octagon. An optical fiber X can couple the light into input optics that starts with the first LP filter, first BP filter, and first PMT detector with the lower bandwidth range. The light then goes through the octagon to the next seven LP filters, BP filters, and PMT detectors for the upper bandwidth ranges. Two or more of the octagon spatial detector arrangement 900A can replace the linear detectors and used with one or more beam splitters in an optical system such as shown in FIG. 3A with a central processor merging/stitching the two or more spectrums together.

FIG. 9B illustrates a hexagon spatial detector arrangement 900B of six detectors and six mirrors. An optical fiber Z can couple the light into the input optics that starts with a first mirror and a first detector with the lower bandwidth range. The light then goes through the hexagon to the next fiver mirrors and five detectors for the upper bandwidth ranges. Alone the hexagon spatial arrangement detector 900B can detect over a wavelength range from 355 nm to 860 nm. If used alone, the mirrors and other optics utilized by the hexagon spatial arrangement detector 900B must support such a broad bandwidth. Signal performance using a single detector can thus be compromised. Furthermore, with a single detector, it is difficult to expand the wavelength bandwidth to go even broader into UV and infrared over a wavelength bandwidth from 330 nm to 1000 nm. Accordingly, two or more hexagon detectors 900B are desirable to use, splitting up the bandwidth as discussed herein with a beam splitter and optimized optical fibres into the two or more hexagon detectors 900B. A central processor can be used to combine (merge/stitch) the separate spectral results from the two or more hexagon detectors 900B into a complete spectral result.

FIG. 9C illustrates a triangle spatial detector arrangement 900C of three PMT detectors with a long pass (LP) filter and a bandpass (BP) filter supporting each. An optical fiber Z can couple the light into the input optics that starts with the first LP filter, BP filter, and PMT detector for the lower bandwidth range. The light then goes through the triangle to the next two LP filters, BP filters, and PMT detectors for the upper bandwidth range. The bandwidth detected by three PMT detectors is very limited. To broaden the bandwidth detected in a flow cytometer system, two or more triangle spatial arrangement detectors 900C are desirable to use, splitting up the bandwidth as discussed herein with a beam splitter and optimized optical fibres into the two or more triangle spatial arrangement detectors 900C. A central processor can be used to combine (merge/stitch) the separate spectral results from the two or more triangle spatial arrangement detectors 900C into a complete spectral result.

While two or more of the same type of detector can be used to improve wavelength bandwidth, a hybrid approach (mix and match) can be employed where two or more differing types of detectors are selected to match particular wavelength bandwidths that each may be more efficient in detecting. For example a linear array detector 360A,360B can be used for one wavelength bandwidth range while a triangle spatial arrangement detector 900C of three PMT detectors can be used for a different wavelength bandwidth range, a hexagon spatial arrangement detector 900B can be used for yet another different wavelength bandwidth range, an octagon spatial detector arrangement 900A can be used for yet another different wavelength bandwidth range, and a grating type detector arrangement 610A,610B can be used for yet another different wavelength bandwidth range. In any case, one or more beam splitters and one or more optical fibers can be used to split up the bandwidth so that more than one of the various detector types can separately detect a respective bandwidth of light and generate digital signals therefrom. The central processor can be used to combine (merge/stitch) the separate spectral results from the two or more different types of detectors into a complete spectral result.

### Advantages

There are a number of advantages to the disclosed embodiments. The disclosed embodiments can make the use of super broadbands of light feasible for detecting characteristics of excited cells in a flow cytometer or cell sorter lab instrument. Even if the pre-existing bandwidth is used, the disclosed embodiments can improve the overall system performance of capturing existing bandwidths of light from excited cells in a flow cytometer or cell sorter lab instrument. There is chromatic dispersion due to the optical devices that are used in collecting and detecting light. Splitting up the wavelength ranges to utilize different optical devices with the different wavelength ranges, such as using two or more fiber optic cables optimized for the different wavelength ranges, can increase the collection efficiency over the entire wavelength range. Splitting up the wavelength ranges can also reduce the number of detectors used in an array detector thereby increasing the signal transmitted to the last detector in the detector array. Additionally, space and costs can be saved with an improvement in performance by using a single package with two separate detectors.

The embodiments of the invention are thus described. While embodiments of the invention have been particularly described, they should not be construed as limited by such embodiments, but rather construed according to the claims that follow below.

While certain exemplary embodiments have been described and shown in the accompanying drawings, it is to be understood that such embodiments are merely illustrative of and not restrictive on the disclosed embodiments, and that the disclosed embodiments not be limited to the specific constructions and arrangements shown and described, since various other modifications may occur to those ordinarily skilled in the art.

When implemented in software, the elements of the embodiments of the invention are essentially the code segments to perform the necessary tasks. The program or code segments can be stored in a processor readable medium to be read out by a processor for execution. The code segments can be downloaded into a processor readable medium via computer networks such as the Internet, Intranet, etc. Alternatively, the code segments can be transmitted from the processor readable medium by a computer data signal embodied in a carrier wave over a transmission medium or communication link to a processor for execution. The processor readable medium may include any medium that can store information. Examples of the processor readable storage medium include an electronic circuit, a semiconductor memory device, a random access memory (RAM), a read only memory (ROM), a flash memory, an erasable programmable read only memory (EPROM), a floppy diskette, a CD-ROM, an optical disk, a magnetic hard disk, etc.

While this specification includes many specifics, these should not be construed as limitations on the scope of the disclosure or of what may be claimed, but rather as descriptions of features specific to particular implementations of the disclosure. Certain features that are described in this specification in the context of separate implementations may also be implemented in combination in a single implementation. Conversely, various features that are described in the context of a single implementation may also be implemented in multiple implementations, separately or in sub-combination. Moreover, although features may be described above as acting in certain combinations and even initially claimed as such, one or more features from a claimed combination may in some cases be excised from the combination, and the claimed combination may be directed to a sub-combination or variations of a sub-combination. Accordingly, the claimed invention is limited only by patented claims that follow below.

1-14. (canceled)

15. A flow cytometer comprising:
a flow cell receiving moving biological cells in a sample fluid and a sheath fluid to wrap around the biological cells, the flow cell having an interrogation region to receive one or more laser beams from one or more lasers to strike the moving biological cells and form fluorescent light, side scatter light, and forward scattered light;
an objective lens near the flow cell to collect the fluorescent light and the side scattered light over a full bandwidth range between a minimum wavelength and a maximum wavelength that is desirable to detect, and focus out of the objective lens, the fluorescent light and the side scattered light over the full bandwidth range into a spot size towards a focal point along a first optical axis;
a first optical coupling device along the first optical axis before the focal point, the first optical coupling device redirecting a first light in a first wavelength range from the minimum wavelength to a first wavelength within the full bandwidth range along a second optical axis, and the first optical coupling device allowing remaining light of the full bandwidth range to pass through along the first optical axis;
a first light detecting device receiving the first light along the second optical axis, the first light detecting device transducing the first light into a first plurality of digital signals representing discrete portions of wavelengths over the first light in the first wavelength range;
a last light detecting device receiving the remaining light along the first optical axis, the last light detecting device transducing the remaining light into a last plurality of digital signals representing discrete portions of wavelengths in the remaining light of the full bandwidth range; and
a processor coupled in communication with the first light detecting device and the last light detecting device, the signal processor receiving the first plurality of digital signals and the last plurality of digital signals and processing the digital signals into a combined spectral signal over the full bandwidth range.

16. The flow cytometer of claim 15, further comprising:
a second optical coupling device along the first optical axis between the first optical coupling device and the focal point, the first optical coupling device redirecting a second light in a second wavelength range from one or more nanometers above the maximum wavelength of the first light to a second wavelength within the full bandwidth range along a third optical axis, the second optical coupling device allowing the remaining light of the full bandwidth range to pass through along the first optical axis; and
a second light detecting device receiving the second light along the third optical axis, the second light detecting device transducing the second light into a second plurality of digital signals representing discrete portions of wavelengths over the second light in the second wavelength range;
wherein the signal processor is further coupled in communication with the second light detecting device to receive the second plurality of digital signals, and wherein the signal processor processes the first, second, and last plurality of digital signals into the combined spectral signal over the full bandwidth range.

17. The flow cytometer of claim 16, further comprising:
a third optical coupling device along the first optical axis between the second optical coupling device and the focal point, the third optical coupling device redirecting a third light in a third wavelength range from one or more nanometers above the maximum wavelength of the second light to a third wavelength within the full bandwidth range along a fourth optical axis, the third optical coupling device allowing the remaining light of the full bandwidth range to pass through along the first optical axis toward the last optical coupling device; and
a third light detecting device receiving the third light along the fourth optical axis, the third light detecting device transducing the third light into a third plurality of digital signals representing discrete portions of wavelengths over the third light in the third wavelength range;
wherein the signal processor is further coupled in communication with the third light detecting device to receive the third plurality of digital signals, and wherein the signal processor processes the first, second, third, and last plurality of digital signals into the combined spectral signal over the full bandwidth range.

18. The flow cytometer of claim 15, wherein:
the first optical coupling device is one or more selected from the group consisting of a lens, a Bragg grating, and/or a dichroic mirror and an optical fiber.

19. The flow cytometer of claim 16, wherein:
each of the optical coupling devices is one or more selected from the group consisting of a lens, a Bragg grating, and/or a dichroic mirror and an optical fiber.

20. The flow cytometer of claim 17, wherein:
each of the optical coupling devices is one or more selected from the group consisting of a lens, a Bragg grating, and/or a dichroic mirror and an optical fiber.

21-26. (canceled)

27. A flow cytometer comprising:
a flow cell receiving moving biological cells in a sample fluid and a sheath fluid to wrap around the biological cells, the flow cell having an interrogation region to receive one or more laser beams from one or more lasers to strike the moving biological cells and form fluorescent light, side scatter light, and forward scattered light;
an objective lens near the flow cell to collect the fluorescent light and the side scattered light over a full bandwidth range between a minimum wavelength and a maximum wavelength that is desirable to detect, and focus out of the objective lens, the fluorescent light and the side scattered light over the full bandwidth range into a spot size towards a focal point along a first optical axis;
a first beam splitter along the first optical axis before the focal point, the first beam splitter redirecting a first wavelength range of light along a second optical axis different from the first optical axis, and allowing a remaining light of the full bandwidth range to pass through along the first optical axis;
a first optical fiber having an input end aligned with the second optical axis to receive the first wavelength range of light and redirect it towards and launch it out an output end;
a first array detector having an input channel coupled to the output end of the first optical fiber to receive the first wavelength range of light, the first array detector transducing the first wavelength range of light into a first plurality of digital signals representing discrete portions of wavelengths in the first wavelength range of light;
a last optical fiber having an input end aligned with the first optical axis to receive the remaining light of the full bandwidth range and redirect it to and launch it out an output end;
a last array detector having an input channel coupled to the output end of the last optical fiber to receive the remaining light of the full bandwidth range, the last array detector transducing the remaining light into a last plurality of digital signals representing discrete portions of wavelengths in the remaining light of the full bandwidth range; and
a signal processor coupled in communication with the first array detector and the last array detector, the signal processor receiving the first plurality of digital signals and the last plurality of digital signals and processing the digital signals into a combined spectral signal over the full bandwidth range.

28. The flow cytometer of claim 27, further comprising:
a second beam splitter along the first optical axis between the first beam splitter and the focal point, the second beam splitter redirecting a second wavelength range of light differing from the first along a third optical axis different from the first optical axis, and allowing the remaining light of the full bandwidth range to pass through along the first optical axis;
a second optical fiber having an input end aligned with the third optical axis to receive the second wavelength range of light and redirect it towards and launch it out an output end; and
a second array detector having an input channel coupled to the output end of the second optical fiber to receive the second wavelength range of light, the second array detector transducing the second wavelength range of light into a second plurality of digital signals representing discrete portions of wavelengths in the second wavelength range of light;
wherein the signal processor is further coupled in communication with the second array detector to receive the second plurality of digital signals, and wherein the signal processor processes the first, second, and last plurality of digital signals into the combined spectral signal over the full bandwidth range.

29. The flow cytometer of claim 28, further comprising:
a third beam splitter along the first optical axis between the second beam splitter and the focal point, the third beam splitter redirecting a third wavelength range of light differing from the first and the second along a fourth optical axis different from the first optical axis, and allowing the remaining light of the full bandwidth range to pass through along the first optical axis;
a third optical fiber having an input end aligned with the fourth optical axis to receive the third wavelength range of light and redirect it towards and launch it out an output end; and
a third array detector having an input channel coupled to the output end of the third optical fiber to receive the third wavelength range of light, the third array detector transducing the third wavelength range of light into a third plurality of digital signals representing discrete portions of wavelengths in the third wavelength range of light;
wherein the signal processor is further coupled in communication with the third array detector to receive the third plurality of digital signals, and wherein the signal processor processes the first, second, third, and last plurality of digital signals into the combined spectral signal over the full bandwidth range.

30. The flow cytometer of claim 29, wherein:
the objective lens near the flow cell is coated with a combined antireflective coating formed out of three or more antireflective coatings based on the full bandwidth range of light.

31. The flow cytometer of claim 30, wherein:
optics in the first input channel of each array detector as well as mirrors and optical filters for first through third detection channels of each array detector are coated with an antireflective coating based on the respective wavelength range of light that is detected.

32. The flow cytometer of claim 29, wherein:
a respective diameter of the first, second, third, and last optical fibres is selected based on the respective wavelength range of light received from the respective beam splitter.

33. The flow cytometer of claim 32, wherein:
each respective input end of the first, second, third, and last optical fibres is positioned at a back focal length distance along respective optical axes from a back face of the objective lens based on the respective wavelength range of light received from the respective beam splitter.

34. The flow cytometer of claim 33, wherein:
each respective input end of the first, second, third, and last optical fibres is coated with an antireflective coating based on the respective wavelength range of light received from the respective beam splitter.

35. The flow cytometer of claim 27, further comprising:
a clock generator coupled to the signal processor and each array detector to synchronize capture of each plurality of digital signals by each array detector.

36. The flow cytometer of claim 27, wherein:
each array detector is a linear array detector including
an optical block to receive light from at least one optical fiber;
a plurality of optical filters aligned in a row on one side of the optical block to transmit differing discrete portions of light and reflect the remaining portion of light, a first optical filter to receive light from the at least one optical fiber through at least one input channel;
a plurality of micromirrors aligned in a row on an opposite side of the optical block to receive the reflected remaining portion of light from respective optical filters but for a last optical filter, the plurality of micromirrors to reflect the remaining portion of light from respective optical filters towards a respective next optical filter in the plurality of optical filters aligned in the row; and
a plurality of photo detectors aligned in a row under the plurality of optical filters to respectively receive the differing discrete portions of light and transduce them into electrical signals.

37. The flow cytometer of claim 36, wherein:
at least two linear array detectors are packaged together into a package sharing the optical block.

38. The flow cytometer of claim 36, wherein:
at least two linear array detectors are packaged together back to back sharing a base to which each optical block and input channel is mounted.
